(19) United States
(12) Patent Application Publication
(10) Pub. No.: US 2015/0288975 A1
(43) Pub. Date: Oct. 8, 2015

(54) METHOD AND APPARATUS FOR ENCODING VIDEO AND METHOD AND APPARTAUS FOR DECODING VIDEO FOR RANDOM ACCESS

(71) Applicant: SAMSUNG ELECTRONICS CO., LTD., Yeongton-gu, Suwon-si Gyeonggi-do (KR)

(72) Inventors: Byeong-doo Choi, Siheung-si (KR); Jeong-hoon Park, Seoul (KR); Tammy Lee, Seoul (KR)

(73) Assignee: SAMSUNG ELECTRONICS CO., LTD., Suwon-si (KR)

(21) Appl. No.: 14/432,031

(22) PCT Filed: Sep. 30, 2013
(86) PCT No.: PCT/KR2013/008760

§ 371 Date: Mar. 27, 2015

Related U.S. Application Data
(60) Provisional application No. 61/706,955, filed on Sep. 28, 2012.

(51) Int. Cl. H04N 19/169; H04N 19/46; H04N 19/172

(52) U.S. Cl. CPC H04N 19/188; H04N 19/172; H04N 19/46

(57) ABSTRACT

A high level syntax of picture for random access is provided. A video decoding method obtains type information of a random access point (RAP) picture from a header of a network adaptive layer (NAL) unit. The type information of the RAP picture may be classified based on whether a leading picture exists and whether a random access decodable leading (RADL) picture exists. It is determined whether the leading picture is decodable based on the type information of the RAP picture and the RAP picture and a decodable leading picture are decoded.

### TECHNICAL FIELD

The present inventive concept relates to video encoding and decoding for random access, and more particularly to, a high level syntax of pictures for random access.

### BACKGROUND ART

As hardware for reproducing and storing high resolution or high quality video content is being developed and supplied, a need for a video codec for effectively encoding or decoding the high resolution or high quality video content is increasing. According to a conventional video codec, a video is encoded according to a limited encoding method based on a macroblock having a predetermined size.

Image data of a spatial region is transformed into coefficients of a frequency region via frequency transformation. According to a video codec, an image is split into blocks having a predetermined size, discrete cosine transformation (DCT) is performed for each respective block, and frequency coefficients are encoded in block units, for rapid calculation for frequency transformation. Compared with image data of a spatial region, coefficients of a frequency region are easily compressed. In particular, since an image pixel value of a spatial region is expressed according to a prediction error via inter prediction or intra prediction of a video codec, when frequency transformation is performed on the prediction error, a large amount of data may be transformed to 0. According to a video codec, an amount of data may be reduced by replacing data that is consecutively and repeatedly generated with small-sized data.

In the video codec, macro blocks are prediction encoded through inter prediction or intra prediction, and encoded image data is output by generating a bitstream according to a predetermined format defined in each video codec.

### DETAILED DESCRIPTION OF THE INVENTION

### Technical Problem

The present inventive concept provides classifying a type of a random access point (RAP) picture used for random access, preparing for a decoding process based on type information of the RAP picture, and skipping a decoding process with respect to unnecessary pictures in a video decoding apparatus.

### Technical Solution

According to exemplary embodiments of the present inventive concept, a type of an RAP picture is classified and type information of the RAP picture is included in a transmission data unit.

### Advantageous Effects

According to exemplary embodiments of the present inventive concept, a decoding side may previously identify type information of an RAP picture included in a network adaptive layer (NAL) unit, prepare for a decoding process based on the identified type information of the RAP picture, and skip a decoding process with respect to unnecessary pictures.

### DESCRIPTION OF THE DRAWINGS

FIG. 1 is a block diagram of a video encoding apparatus based on coding units having a tree structure, according to an exemplary embodiment of the present invention;

FIG. 2 is a block diagram of a video decoding apparatus based on coding units having a tree structure, according to an exemplary embodiment of the present invention;

FIG. 3 is a diagram for describing a concept of coding units according to an exemplary embodiment of the present invention;

FIG. 4 is a block diagram of an image encoder based on coding units, according to an embodiment of the present invention;

FIG. 5 is a block diagram of an image decoder based on coding units, according to an exemplary embodiment of the present invention;

FIG. 6 is a diagram illustrating deeper coding units according to depths and prediction units, according to an exemplary embodiment of the present invention;

FIG. 7 is a diagram for describing a relationship between a coding unit and transformation units, according to an exemplary embodiment of the present invention;

FIG. 8 is a diagram for describing encoding information of coding units corresponding to a coded depth, according to an exemplary embodiment of the present invention;

FIG. 9 is a diagram of deeper coding units according to depths according to an exemplary embodiment of the present invention;

FIGS. 10 through 12 are diagrams for describing a relationship between coding units, prediction units, and frequency transformation units, according to an exemplary embodiment of the present invention;

FIG. 13 is a diagram for describing a relationship between a coding unit, a prediction unit, and a transformation unit, according to the encoding mode information of Table 1;

FIG. 14 is a diagram for explaining a hierarchical classification of video encoding and decoding processes according to an exemplary embodiment of the present invention;

FIG. 15 illustrates an example of a header of a network adaptive layer (NAL) unit according to an exemplary embodiment of the present invention;

FIG. 16 is a block diagram of a video encoding apparatus according to an exemplary embodiment of the present invention;

FIG. 17 is a flowchart of a video decoding method according to an exemplary embodiment of the present invention;

FIG. 18 is a reference view for explaining a leading picture according to an exemplary embodiment of the present invention;

FIGS. 19A and 19B are reference views for explaining an instantaneous decoder refresh (IDR) picture according to an exemplary embodiment of the present invention;

FIG. 20 shows a clean random access (CRA) picture having a random access skipped leading (RASL) picture;

FIG. 21 shows an example of an RASL picture and a random access decodable leading (RADL) picture with respect to a broken link access (BLA) picture;

FIG. 22 illustrates a hierarchical temporal prediction structure according to an exemplary embodiment of the present invention;

FIG. 23A is a diagram of a temporal sublayer access (TSA) picture according to an exemplary embodiment of the present invention;

FIG. 23B is a diagram of a stepwise temporal sublayer access (STSA) picture according to an exemplary embodiment of the present invention;

FIG. 24 illustrates an example of type information of a random access point (RAP) picture according to an exemplary embodiment of the present invention;

FIG. 25 illustrates an example of type information of a TSA picture and an STSA picture according to an exemplary embodiment of the present invention;

FIG. 26 is a block diagram of a video decoding apparatus according to an exemplary embodiment of the present invention; and

FIG. 27 is a flowchart of a video decoding method according to an exemplary embodiment of the present invention.

### BEST MODE

According to an aspect of the present invention, there is provided a video decoding method comprising: obtaining a network adaptive layer (NAL) unit of a video coding layer comprising encoding information of a random access point (RAP) picture for random access; obtaining type information of the RAP picture classified based on whether a leading picture that precedes the RAP picture in an output order but is decoded after the RAP picture in a decoding order exists and whether a random access decodable leading (RADL) picture exists among the leading picture, from a header of the NAL unit; determining whether the leading picture exists and whether the RADL picture exists with respect to the RAP picture based on the obtained type information of the RAP picture; and decoding the RAP picture and the decodable leading picture of the RAP picture by determining whether the leading picture of the RAP picture is decodable based on a result of the determining.

According to another aspect of the present invention, there is provided a video decoding apparatus comprising: a receiver for obtaining a network adaptive layer (NAL) of a video coding layer comprising encoding information of a random access point (RAP) picture for random access, and obtaining type information of the RAP picture classified based on whether a leading picture that precedes the RAP picture in an output order but is decoded after the RAP picture in a decoding order exists and whether a random access decodable leading (RADL) picture exists among the leading picture, from a header of the NAL unit; and an image decoder for determining whether the leading picture exists and whether the RADL picture exists with respect to the RAP picture based on the obtained type information of the RAP picture, and determining whether the leading picture of the RAP picture is decodable based on a result of the determining and decoding the RAP picture and the decodable leading picture of the RAP picture.

According to another aspect of the present invention, there is provided a video encoding method comprising: encoding pictures constituting an image sequence by performing inter prediction and intra prediction; and classifying a random access point (RAP) picture based on whether a leading picture that precedes the RAP picture according to an output order but is decoded after the RAP picture in a decoding order of a decoder exists and whether a random access decodable leading (RADL) picture exists among the leading picture, and generating a network adaptive layer (NAL) unit of a video coding layer comprising encoding information of the RAP picture and type information of the classified RAP picture.

According to another aspect of the present invention, there is provided a video encoding apparatus comprising: an image encoder for encoding pictures constituting an image sequence by performing inter prediction and intra prediction; and an output unit for classifying a random access point (RAP) picture based on whether a leading picture that precedes the RAP picture in an output order but is decoded after the RAP picture in a decoding order of a decoder exists and whether a random access decodable leading (RADL) picture exists among the leading picture, and generating a network adaptive layer (NAL) unit of a video coding layer comprising encoding information of the RAP picture and type information of the classified RAP picture.

### MODE OF THE INVENTION

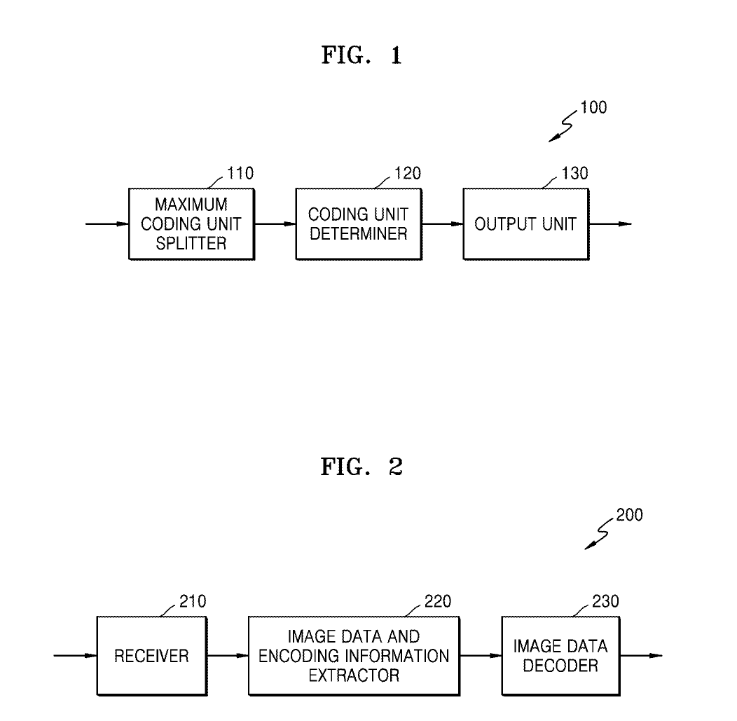

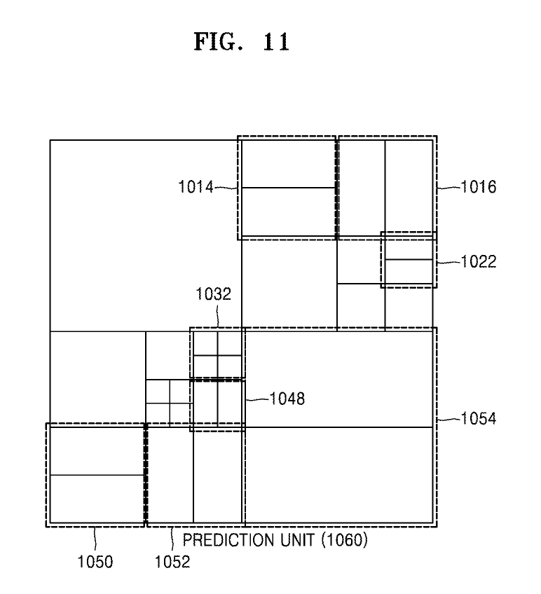

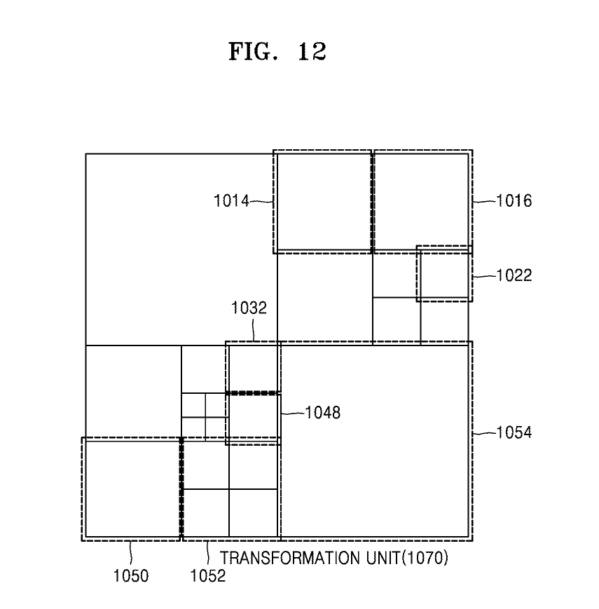

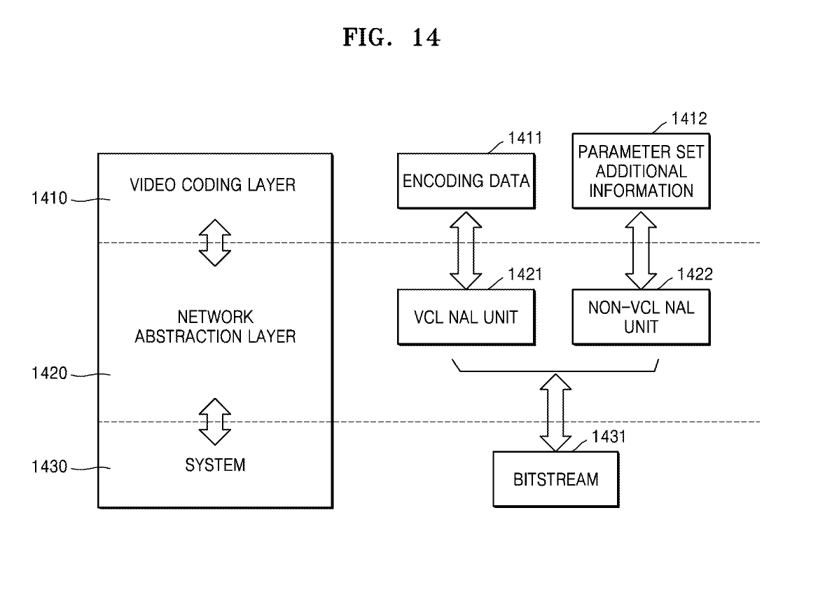

A video encoding method and apparatus and a video decoding method and apparatus based on coding units having a tree structure, according to exemplary embodiments of the present invention, will be described with reference to FIGS. 1 through 13. A method and apparatus for generating a network adaptive layer (NAL) unit bitstream including encoding information with respect to a random access point (RAP) picture for random access and a method and apparatus for decoding video based on the NAL unit bitstream including the encoding information with respect to the RAP picture will be described with reference to FIGS. 14 through 27. Hereinafter, the term ‘image’ may refer to a still image or a moving picture, that is, a video itself.

FIG. 1 is a block diagram of a video encoding apparatus 100 based on coding units having a tree structure, according to an embodiment of the present invention.

The video encoding apparatus 100 accompanied by a video prediction based on the coding units having the tree structure according to an embodiment includes a maximum coding unit splitter 110, a coding unit determiner 120, and an output unit 130. Hereinafter, for convenience of description, the video encoding apparatus 100 accompanied by the video prediction based on the coding units having the tree structure, according to an embodiment, is referred to as a “video encoding apparatus 100”.

The maximum coding unit splitter 110 may split a current picture based on a maximum coding unit that is a coding unit having a maximum size for the current picture of an image. If the current picture is larger than the maximum coding unit, image data of the current picture may be split into the at least one maximum coding unit. The maximum coding unit according to an embodiment may be a data unit having a size of 32×32, 64×64, 128×128, or 256×256, wherein a shape of the data unit is a square having a width and length in squares of 2. The image data may be output to the coding unit determiner 120 according to the at least one maximum coding unit.

A coding unit according to an embodiment may be characterized by a maximum size and a depth. The depth denotes a number of times the coding unit is spatially split from the maximum coding unit, and as the depth increases, deeper coding units according to depths may be split from the maximum coding unit to a minimum coding unit. A depth of the maximum coding unit is an uppermost depth and a depth of the minimum coding unit is a lowermost depth. Since a size of a coding unit corresponding to each depth decreases as the depth of the maximum coding unit increases, a coding unit corresponding to an upper depth may include a plurality of coding units corresponding to lower depths.

As described above, the image data of the current picture is split into the maximum coding units according to a maximum size of the coding unit, and each of the maximum coding units may include deeper coding units that are split according to depths. Since the maximum coding unit according to an embodiment is split according to depths, the image data of a spatial domain included in the maximum coding unit may be hierarchically classified according to depths.

A maximum depth and a maximum size of a coding unit, which limit a total number of times a height and a width of the maximum coding unit are hierarchically split may be previously set.

The coding unit determiner 120 encodes at least one split region obtained by splitting a region of the maximum coding unit according to depths, and determines a depth to output final encoding results according to the at least one split region. In other words, the coding unit determiner 120 determines a coded depth by encoding the image data in the deeper coding units according to depths, according to the maximum coding unit of the current picture, and selecting a depth having a least encoding error. The determined coded depth and the image data according to the maximum coding unit are output.

The image data in the maximum coding unit is encoded based on the deeper coding units corresponding to at least one depth equal to or less than the maximum depth, and encoding results are compared based on each of the deeper coding units. A depth having the least encoding error may be selected after comparing encoding errors of the deeper coding units. At least one coded depth may be selected for each maximum coding unit.

A size of the maximum coding unit is split as a coding unit is hierarchically split according to depths, and a number of coding units increases. Also, even if coding units correspond to the same depth in one maximum coding unit, it is determined whether to split each of the coding units corresponding to the same depth to a lower depth by measuring an encoding error of the data of each coding unit, separately. Accordingly, even when data is included in one maximum coding unit, the encoding errors according to depths may differ according to regions, and thus the coded depths may differ according to regions. Thus, one or more coded depths may be set for one maximum coding unit, and the data of the maximum coding unit may be divided according to coding units of the one or more coded depths.

Accordingly, the coding unit determiner 120 according to an embodiment may determine coding units having a tree structure included in a current maximum coding unit. The ‘coding units having a tree structure’ according to an embodiment of the present invention include coding units corresponding to a depth determined to be a coded depth, from among all deeper coding units included in the maximum coding unit. A coding unit of a coded depth may be hierarchically determined according to depths in the same region of the maximum coding unit, and may be independently determined in different regions. Similarly, a coded depth in a current region may be independently determined from a coded depth in another region.

A maximum depth according to an embodiment is an index related to a number of times splitting is performed from a maximum coding unit to a minimum coding unit. A first maximum depth according to an embodiment may denote a total number of times splitting is performed from the maximum coding unit to the minimum coding unit. A second maximum depth according to an embodiment may denote a total number of depth levels from the maximum coding unit to the minimum coding unit. For example, when a depth of the maximum coding unit is 0, a depth of a coding unit in which the maximum coding unit is split once may be set to 1, and a depth of a coding unit in which the maximum coding unit is split twice may be set to 2. In this case, if the minimum coding unit is a coding unit obtained by splitting the maximum coding unit four times, 5 depth levels of depths 0, 1, 2, 3 and 4 exist, and thus the first maximum depth may be set to 4 and the second maximum depth may be set to 5.

Prediction encoding and frequency transformation may be performed according to the maximum coding unit. The prediction encoding and the transformation are also performed based on the deeper coding units according to a depth equal to or depths less than the maximum depth, according to the maximum coding unit.

Since a number of deeper coding units increases whenever the maximum coding unit is split according to depths, encoding including the prediction encoding and the frequency transformation has to be performed on all of the deeper coding units generated as the depth increases. For convenience of description, the prediction encoding and the frequency transformation will now be described based on a coding unit of a current depth, from among at least one maximum coding unit.

The video encoding apparatus 100 according to an embodiment may variously select a size or shape of a data unit for encoding the image data. In order to encode the image data, operations, such as prediction encoding, frequency transformation, and entropy encoding, are performed, and at this time, the same data unit may be used for all operations or different data units may be used for each operation.

For example, the video encoding apparatus 100 may select not only a coding unit for encoding the image data, but also a data unit different from the coding unit so as to perform the prediction encoding on the image data in the coding unit.

In order to perform prediction encoding in the maximum coding unit, the prediction encoding may be performed based on a coding unit corresponding to a coded depth, i.e., based on a coding unit that is no longer split into coding units corresponding to a lower depth. Hereinafter, the coding unit that is no longer split and becomes a basis unit for prediction encoding will now be referred to as a ‘prediction unit’. A partition obtained by splitting the prediction unit may include a prediction unit and a data unit obtained by splitting at least one of a height and a width of the prediction unit.

For example, when a coding unit of 2N×2N (where N is a positive integer) is no longer split, the coding unit may become a prediction unit of 2N×2N and a size of a partition may be 2N×2N, 2N×N, N×2N, or N×N. Examples of a partition type include symmetrical partitions that are obtained by symmetrically splitting a height or width of the prediction unit, partitions obtained by asymmetrically splitting the height or width of the prediction unit, such as 1:n or n:1, partitions that are obtained by geometrically splitting the prediction unit, and partitions having arbitrary shapes.

A prediction mode of the prediction unit may be at least one of an intra mode, a inter mode, and a skip mode. For example, the intra mode or the inter mode may be performed on the partition of 2N×2N, 2N×N, N×2N, or N×N. Also, the skip mode may be performed only on the partition of 2N×2N. The encoding is independently performed on one prediction unit in a coding unit, thereby selecting a prediction mode having a least encoding error.

The video encoding apparatus 100 according to an embodiment may also perform the transformation on the image data in a coding unit based not only on the coding unit for encoding the image data but also based on a data unit that is different from the coding unit. In order to perform the transformation in the coding unit, the transformation may be performed based on a transformation unit having a size smaller than or equal to the coding unit. For example, the transformation unit may include a transformation unit for an intra mode and a data unit for an inter mode.

Similarly to the coding unit in a tree structure according to an embodiment, the transformation unit in the coding unit may be recursively split into smaller sized transformation units, and thus, residual data in the coding unit may be divided according to the transformation unit having a tree structure according to transformation depths.

A transformation depth indicating a number of times splitting is performed to reach the transformation unit by splitting the height and width of the coding unit may also be set in the transformation unit according to an embodiment. For example, in a current coding unit of 2N×2N, a transformation depth may be 0 when the size of a transformation unit is 2N×2N, may be 1 when the size of a transformation unit is N×N, and may be 2 when the size of a transformation unit is N/2×N/2. That is, the transformation unit having the tree structure may also be set according to transformation depths.

Encoding information according to coding units corresponding to a coded depth requires not only information about the coded depth but also about information related to prediction encoding and transformation. Accordingly, the coding unit determiner 120 not only determines a coded depth having a least encoding error but also determines a partition type in a prediction unit, a prediction mode according to prediction units, and a size of a transformation unit for transformation.

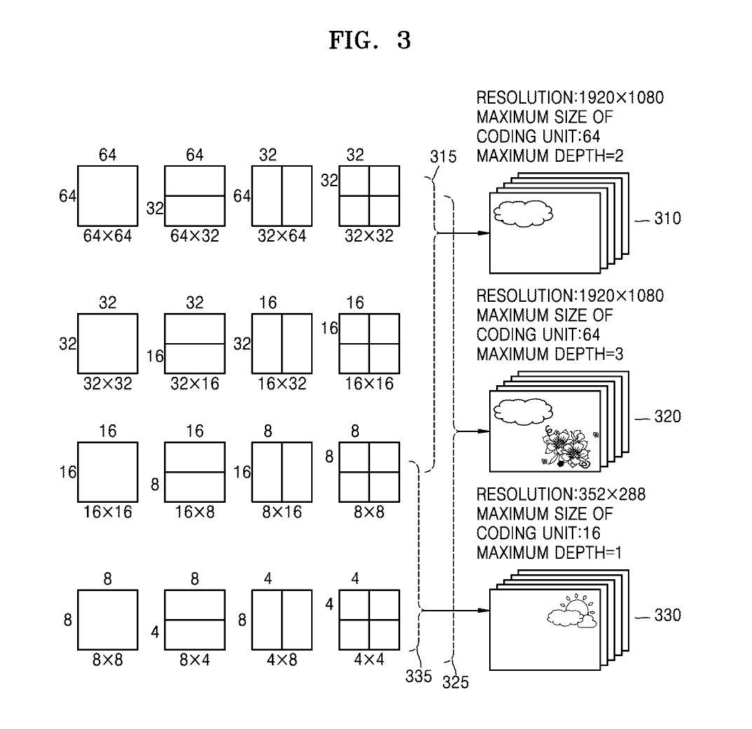

Coding units having a tree structure in a maximum coding unit and a method of determining a prediction unit/partition and a transformation unit according to an embodiment will be described in detail later with reference to FIGS. 3 through 13.

The coding unit determiner 120 may measure an encoding error of deeper coding units according to depths by using Rate-Distortion (RD) Optimization based on Lagrangian multipliers.

The output unit 130 outputs the image data of the maximum coding unit, which is encoded based on the at least one coded depth determined by the coding unit determiner 120, and information about the encoding mode according to the coded depth, in bitstreams.

The encoded image data may be obtained by encoding residual data of an image.

The information about the encoding mode according to coded depth may include information about the coded depth, the partition type in the prediction unit, the prediction mode, and the size of the transformation unit.

The information about the coded depth may be defined by using split information according to depths, which indicates whether encoding is performed on coding units of a lower depth instead of a current depth. If the current depth of the current coding unit is the coded depth, the encoding is performed on the current coding unit of the current depth, and thus the split information may be defined not to split the current coding unit to a lower depth. Alternatively, if the current depth of the current coding unit is not the coded depth, the encoding is performed on the coding unit of the lower depth, and thus the split information may be defined to split the current coding unit to obtain the coding units of the lower depth.

If the current depth is not the coded depth, encoding is performed on the coding unit that is split into the coding unit of the lower depth. Since at least one coding unit of the lower depth exists in one coding unit of the current depth, the encoding is repeatedly performed on each coding unit of the lower depth, and thus the encoding may be recursively performed for the coding units having the same depth.

Since the coding units having a tree structure are determined for one maximum coding unit and information about at least one encoding mode is determined for a coding unit of a coded depth, information about at least one encoding mode may be determined for one maximum coding unit. Also, a coded depth of the data of the maximum coding unit may be different according to locations since the data is hierarchically split according to depths, and thus information about the coded depth and the encoding mode may be set for the data.

Accordingly, the output unit 130 according to an embodiment may assign encoding information about a corresponding coded depth and an encoding mode to at least one of the coding unit, the prediction unit, and a minimum unit included in the maximum coding unit.

The minimum unit according to an embodiment is a rectangular data unit obtained by splitting the minimum coding unit constituting a lowermost depth by 4. Alternatively, the minimum unit may be a maximum rectangular data unit that may be included in all of the coding units, prediction units, partition units, and transformation units included in the maximum coding unit.

For example, the encoding information output through the output unit 130 may be classified into encoding information according to deeper coding units according to depths, and encoding information according to prediction units. The encoding information according to the deeper coding units according to depths may include the information about the prediction mode and about the size of the partitions. The encoding information according to the prediction units may include information about an estimated direction of an inter mode, about a reference image index of the inter mode, about a motion vector, about a chroma component of an intra mode, and about an interpolation method of the intra mode.

Also, information about a maximum size of the coding unit defined according to pictures, slices, or GOPs, and information about a maximum depth may be inserted into a header of a bitstream, a sequence parameter set, or a picture parameter set, etc.

Information about a maximum size of the transformation unit allowed for a current video and information about a minimum size of the transformation unit may be output through the header of the bitstream, the sequence parameter set, or the picture parameter set, etc. The output unit 130 may encode and output reference information, prediction information, unidirectional prediction information, slice-type information including a fourth slice type described with reference to FIG. 1 above.

In the video encoding apparatus 100 according to a simplest embodiment, the deeper coding unit is a coding unit obtained by dividing a height or width of a coding unit of an upper depth, which is one layer above, by two. In other words, when the size of the coding unit of the current depth is 2N×2N, the size of the coding unit of the lower depth is N×N. Also, the coding unit of the current depth having the size of 2N×2N may include a maximum number of 4 coding units of the lower depth.

Accordingly, the video encoding apparatus 100 according to an embodiment may form the coding units having the tree structure by determining coding units having an optimum shape and an optimum size for each maximum coding unit, based on the size of the maximum coding unit and the maximum depth determined considering characteristics of the current picture. Also, since encoding may be performed on each maximum coding unit by using any one of various prediction modes and transformations, an optimum encoding mode may be determined considering image characteristics of the coding unit of various image sizes.

Thus, if an image having high resolution or a large data amount is encoded in a conventional macroblock, a number of macroblocks per picture excessively increases. Accordingly, a number of pieces of compressed information generated for each macroblock increases, and thus it is difficult to transmit the compressed information and data compression efficiency decreases. However, by using the video encoding apparatus 100 according to an embodiment, image compression efficiency may be increased since a coding unit is adjusted while considering characteristics of an image while increasing a maximum size of a coding unit while considering a size of the image.

FIG. 2 is a block diagram of a video decoding apparatus 200 based on coding units having a tree structure, according to an embodiment of the present invention.

The video decoding apparatus 200 accompanied by a video prediction includes a receiver 210, an image data and encoding information extractor 220, and an image data decoder 230. Hereinafter, for convenience of description, the video decoding apparatus 200 accompanied by the video prediction based on the coding units having the tree structure according to an embodiment is referred to as a “video decoding apparatus 200”.

Definitions of various terms, such as a coding unit, a depth, a prediction unit, a transformation unit, and information about various encoding modes, for various operations of the video decoding apparatus 200 are identical to those described with reference to FIG. 1 and the video encoding apparatus 100.

The receiver 210 receives and parses a bitstream of an encoded video. The image data and encoding information extractor 220 extracts encoded image data for each coding unit from the parsed bitstream, wherein the coding units have a tree structure according to each maximum coding unit, and outputs the extracted image data to the image data decoder 230. The image data and encoding information extractor 220 may extract information about a maximum size of a coding unit of a current picture, from a header about the current picture.

Also, the image data and encoding information extractor 220 extracts information about a coded depth and an encoding mode for the coding units having the tree structure according to each maximum coding unit, from the parsed bitstream. The extracted information about the coded depth and the encoding mode is output to the image data decoder 230. In other words, the image data in a bit stream is split into the maximum coding unit so that the image data decoder 230 decodes the image data for each maximum coding unit.

The information about the coded depth and the encoding mode according to the maximum coding unit may be set for information about at least one coded depth, and information about an encoding mode according to each coded depth may include information about a partition type of a corresponding coding unit corresponding to the coded depth, a prediction mode, and a size of a transformation unit. Also, split information according to depths may be extracted as the information about the coded depth.

The information about the coded depth and the encoding mode according to each maximum coding unit extracted by the image data and encoding information extractor 220 is information about a coded depth and an encoding mode determined to generate a least encoding error when an encoder, such as the video encoding apparatus 100, repeatedly performs encoding for each deeper coding unit according to depths according to each maximum coding unit. Accordingly, the video decoding apparatus 200 may restore an image by decoding the image data according to an encoding mode that generates the least encoding error.

Since encoding information about the coded depth and the encoding mode according to an embodiment may be assigned to a predetermined data unit from among a corresponding coding unit, a prediction unit, and a minimum unit, the image data and encoding information extractor 220 may extract the information about the coded depth and the encoding mode according to the predetermined data units. When the information about the coded depth of the corresponding maximum coding unit and the encoding mode is recorded according to the predetermined data units, the predetermined data units having the same information about the coded depth and the encoding mode may be inferred to be the data units included in the same maximum coding unit.

The image data decoder 230 restores the current picture by decoding the image data in each maximum coding unit based on the information about the coded depth and the encoding mode according to the maximum coding units. In other words, the image data decoder 230 may decode the encoded image data based on the extracted information about the partition type, the prediction mode, and the transformation unit for each coding unit from among the coding units having the tree structure included in each maximum coding unit. A decoding process may include prediction including intra prediction and motion compensation, and inverse transformation.

The image data decoder 230 may perform intra prediction or motion compensation according to a partition and a prediction mode of each coding unit, based on the information about the partition type and the prediction mode of the prediction unit of the coding unit according to coded depths.

Also, the image data decoder 230 may read transformation unit information according to the tree structure according to coding units and perform inverse transformation based on each transformation unit in the coding unit, so as to perform the inverse transformation according to maximum coding units. A pixel value of the spatial region of the coding unit may be reconstructed.

The image data decoder 230 may determine a coded depth of a current maximum coding unit by using split information according to depths. If the split information indicates that image data is no longer split in the current depth, the current depth is a coded depth. Accordingly, the image data decoder 230 may decode encoded data of the current depth by using the information about the partition type of the prediction unit, the prediction mode, and the size of the transformation unit for image data of the current maximum coding unit.

In other words, data units containing the encoding information including the same split information may be gathered by observing the encoding information set assigned for the predetermined data unit from among the coding unit, the prediction unit, and the minimum unit, and the gathered data units may be considered to be one data unit to be decoded by the image data decoder 230 in the same encoding mode.

The video decoding apparatus 200 according to an embodiment may obtain information about a coding unit that generates the least encoding error when encoding is recursively performed for each maximum coding unit, and may use the information to decode the current picture. In other words, the coding units having the tree structure determined to be the optimum coding units in each maximum coding unit may be decoded.

Accordingly, even if image data has high resolution and a large amount of data, the image data may be efficiently decoded and restored according to a size of a coding unit and an encoding mode, which are adaptively determined according to characteristics of an image, by using information about an optimum encoding mode received from an encoder.

FIG. 3 is a diagram for describing a concept of hierarchical coding units according to an embodiment of the present invention.

A size of a coding unit may be expressed in width×height, and examples of the size of the coding unit may include 64×64, 32×32, 16×16, and 8×8. A coding unit of 64×64 may be split into partitions of 64×64, 64×32, 32×64, or 32×32, and a coding unit of 32×32 may be split into partitions of 32×32, 32×16, 16×32, or 16×16, a coding unit of 16×16 may be split into partitions of 16×16, 16×8, 8×16, or 8×8, and a coding unit of 8×8 may be split into partitions of 8×8, 8×4, 4×8, or 4×4.

In video data 310, a resolution is set to 1920×1080, a maximum size of a coding unit is set to 64, and a maximum depth is set to 2. In video data 320, a resolution is set to 1920×1080, a maximum size of a coding unit is set to 64, and a maximum depth is set to 3. In video data 330, a resolution is set to 352×288, a maximum size of a coding unit is set to 16, and a maximum depth is set to 1. The maximum depth shown in FIG. 3 denotes a total number of splits from a maximum coding unit to a minimum decoding unit.

If a resolution is high or a data amount is large, a maximum size of a coding unit may be large so as to not only increase encoding efficiency but also to accurately reflect characteristics of an image. Accordingly, the maximum size of the coding unit of the video data 310 and 320 having the higher resolution than the video data 330 may be 64.

Since the maximum depth of the video data 310 is 2, coding units 315 of the video data 310 may include a maximum coding unit having a long axis size of 64, and coding units having long axis sizes of 32 and 16 since depths are increased to two layers by splitting the maximum coding unit twice. Meanwhile, since the maximum depth of the video data 330 is 1, coding units 335 of the video data 330 may include a maximum coding unit having a long axis size of 16, and coding units having a long axis size of 8 since depths are increased to one layer by splitting the maximum coding unit once.

Since the maximum depth of the video data 320 is 3, coding units 325 of the video data 320 may include a maximum coding unit having a long axis size of 64, and coding units having long axis sizes of 32, 16, and 8 since the depths are increased to 3 layers by splitting the maximum coding unit three times. As a depth increases, detailed information may be more precisely expressed.

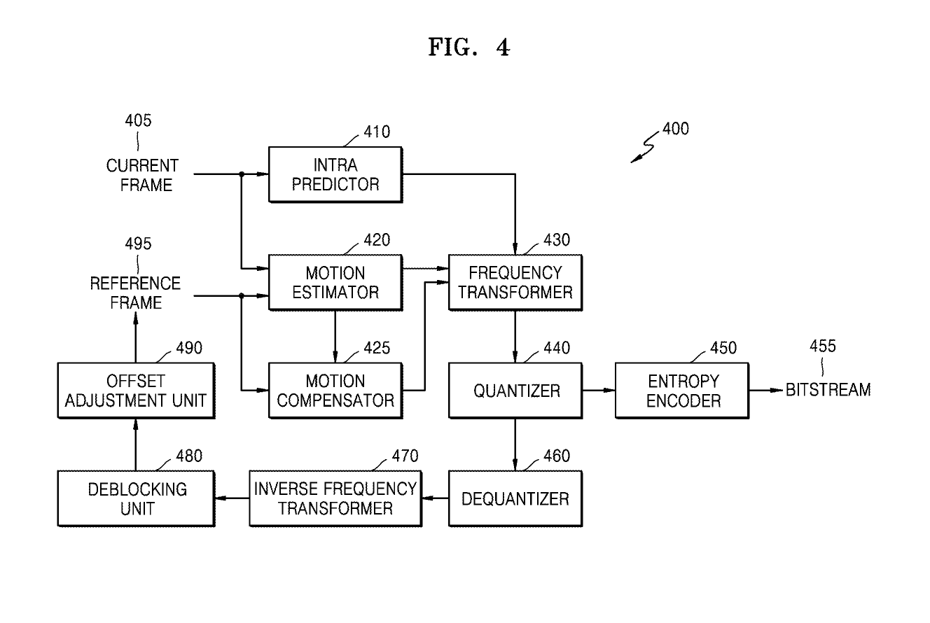

FIG. 4 is a block diagram of an image encoder 400 based on coding units, according to an embodiment of the present invention.

The image encoder 400 according to an embodiment performs operations of the coding unit determiner 120 of the video encoding apparatus 100 to encode image data. In other words, an intra predictor 410 performs intra prediction on coding units in an intra mode, from among a current frame 405, and a motion estimator 420 and a motion compensator 425 perform inter estimation and motion compensation on coding units in an inter mode from among the current frame 405 by using the current frame 405 and a reference frame 495.

Data output from the intra predictor 410, the motion estimator 420, and the motion compensator 425 is output as a quantized transformation coefficient through a frequency transformer 430 and a quantizer 440. The quantized transformation coefficient is restored as data in a spatial domain through an inverse quantizer 460 and an inverse frequency transformer 470, and the restored data in the spatial domain is output as the reference frame 495 after being post-processed through a deblocking unit 480 and an offset adjustment unit 490. The quantized transformation coefficient may be output as a bitstream 455 through an entropy encoder 450.

In order for the image encoder 400 to be applied in the video encoding apparatus 100 according to an embodiment, all elements of the image encoder 400, i.e., the intra predictor 410, the motion estimator 420, the motion compensator 425, the frequency transformer 430, the quantizer 440, the entropy encoder 450, the inverse quantizer 460, the inverse frequency transformer 470, the deblocking unit 480, and the offset adjustment unit 490 have to perform operations based on each coding unit from among coding units having a tree structure while considering the maximum depth of each maximum coding unit.

Specifically, the intra predictor 410, the motion estimator 420, and the motion compensator 425 have to determine partitions and a prediction mode of each coding unit from among the coding units having the tree structure while considering the maximum size and the maximum depth of a current maximum coding unit, and the frequency transformer 430 has to determine the size of the transformation unit in each coding unit from among the coding units having the tree structure.

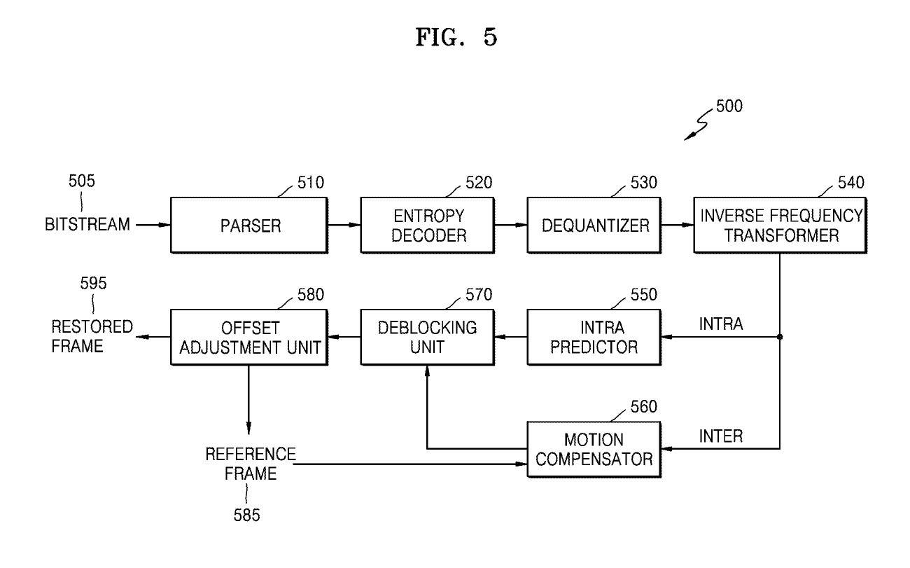

FIG. 5 is a block diagram of an image decoder 500 based on coding units, according to an embodiment of the present invention.

A parser 510 parses encoded image data to be decoded and information about encoding required for decoding from a bitstream 505. The encoded image data is output as inverse quantized data through an entropy decoder 520 and an inverse quantizer 530, and the inverse quantized data is restored to image data in a spatial domain through an inverse frequency transformer 540.

An intra predictor 550 performs intra prediction on coding units in an intra mode with respect to the image data in the spatial domain, and a motion compensator 560 performs motion compensation on coding units in an inter mode by using a reference frame 585.

The data in the spatial domain, which passed through the intra predictor 550 and the motion compensator 560, may be output as a restored frame 595 after being post-processed through a deblocking unit 570 and an offset adjustment unit 580. Also, the data, which is post-processed through the deblocking unit 570 and the offset adjustment unit 580, may be output as the reference frame 585.

In order to decode the image data in the image data decoder 230 of the video decoding apparatus 200, the image decoder 500 may perform operations that are performed after operations of the parser 510 are performed.

In order for the image decoder 500 to be applied in the video decoding apparatus 200 according to an embodiment, all elements of the image decoder 500, i.e., the parser 510, the entropy decoder 520, the inverse quantizer 530, the inverse frequency transformer 540, the intra predictor 550, the motion compensator 560, the deblocking unit 570, and the offset adjustment unit 580 have to perform operations based on coding units having a tree structure for each maximum coding unit.

Specifically, the intra predictor 550 and the motion compensator 560 have to determine partitions and a prediction mode for each of the coding units having the tree structure, and the inverse frequency transformer 540 has to determine a size of a transformation unit for each coding unit.

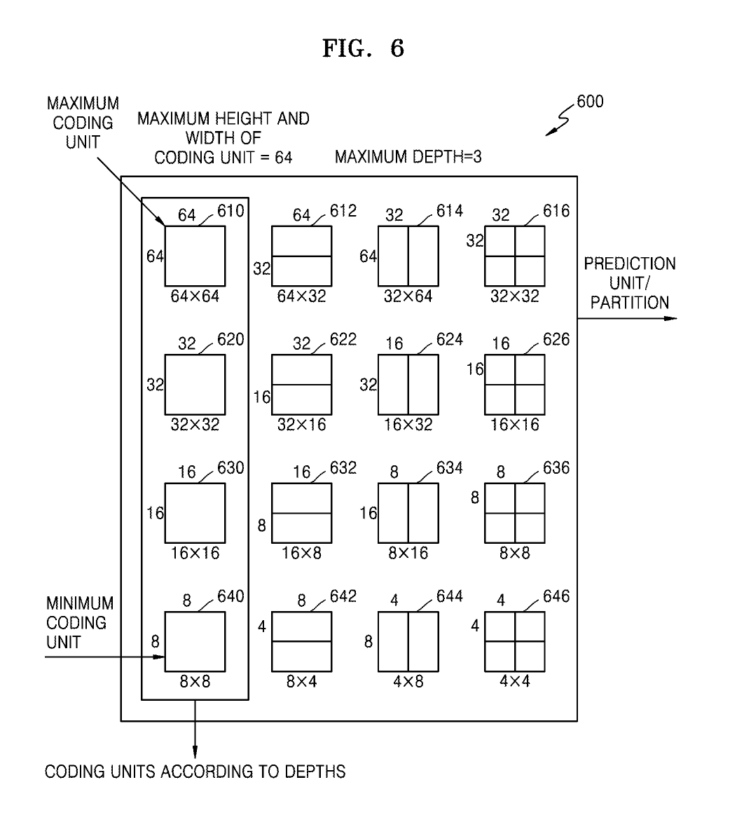

FIG. 6 is a diagram illustrating deeper coding units according to depths and partitions, according to an embodiment of the present invention.

The video encoding apparatus 100 and the video decoding apparatus 200 use hierarchical coding units so as to consider characteristics of an image. A maximum height, a maximum width, and a maximum depth of coding units may be adaptively determined according to the characteristics of the image, or may be differently set by a user. Sizes of deeper coding units according to depths may be determined according to the maximum size of the coding unit which is previously set.

In a hierarchical structure 600 of coding units according to an embodiment, the maximum height and the maximum width of the coding units are each 64, and the maximum depth is 4. Since a depth increases along a vertical axis of the hierarchical structure 600 of the coding units according to an embodiment, a height and a width of the deeper coding unit are each split. Also, a prediction unit and partitions, which are bases for prediction encoding of each deeper coding unit, are shown along a horizontal axis of the hierarchical structure 600 of the coding units.

In other words, a coding unit 610 is a maximum coding unit in the hierarchical structure 600 of the coding units, wherein a depth is 0 and a size, i.e., a height by width, is 64×64. The depth increases along the vertical axis, and a coding unit 620 having a size of 32×32 and a depth of 1, a coding unit 630 having a size of 16×16 and a depth of 2, and a coding unit 640 having a size of 8×8 and a depth of 3. The coding unit 640 having the size of 8×8 and the depth of 3 is a minimum coding unit.

The prediction unit and the partitions of a coding unit are arranged along the is horizontal axis according to each depth. In other words, if the coding unit 610 having the size of 64×64 and the depth of 0 is a prediction unit, the prediction unit may be split into partitions included in the coding unit 610, i.e. a partition 610 having a size of 64×64, partitions 612 having the size of 64×32, partitions 614 having the size of 32×64, or partitions 616 having the size of 32×32.

Similarly, a prediction unit of the coding unit 620 having the size of 32×32 and the depth of 1 may be split into partitions included in the coding unit 620, i.e. a partition 620 having a size of 32×32, partitions 622 having a size of 32×16, partitions 624 having a size of 16×32, and partitions 626 having a size of 16×16.

Similarly, a prediction unit of the coding unit 630 having the size of 16×16 and the depth of 2 may be split into partitions included in the coding unit 630, i.e. a partition having a size of 16×16 included in the coding unit 630, partitions 632 having a size of 16×8, partitions 634 having a size of 8×16, and partitions 636 having a size of 8×8.

Similarly, a prediction unit of the coding unit 640 having the size of 8×8 and the depth of 3 may be split into partitions included in the coding unit 640, i.e. a partition having a size of 8×8 included in the coding unit 640, partitions 642 having a size of 8×4, partitions 644 having a size of 4×8, and partitions 646 having a size of 4×4.

Finally, the coding unit 640 having the size of 8×8 and the depth of 3 is the minimum coding unit and a coding unit of a lowermost depth.

In order to determine a coded depth of the maximum coding unit 610, the coding unit determiner 120 of the video encoding apparatus 100 according to an embodiment has to perform encoding for coding units corresponding to each depth included in the maximum coding unit 610.

A number of deeper coding units according to depths including data in the same range and the same size increases as the depth increases. For example, four coding units corresponding to a depth of 2 are required to cover data that is included in one coding unit corresponding to a depth of 1. Accordingly, in order to compare encoding results of the same data according to depths, the coding unit corresponding to the depth of 1 and four coding units corresponding to the depth of 2 have to be each encoded.

In order to perform encoding according to each depth, a representative encoding error that is a least encoding error in the corresponding depth may be selected by performing encoding for each prediction unit in the deeper coding units, along the horizontal axis of the hierarchical structure 600 of the coding units. Alternatively, the least encoding error may be searched for by comparing representative encoding errors according to depths by performing encoding for each depth as the depth increases along the vertical axis of the hierarchical structure 600 of the coding units. A depth and a partition having the least encoding error in the maximum coding unit 610 may be selected as the coded depth and a partition type of the maximum coding unit 610.

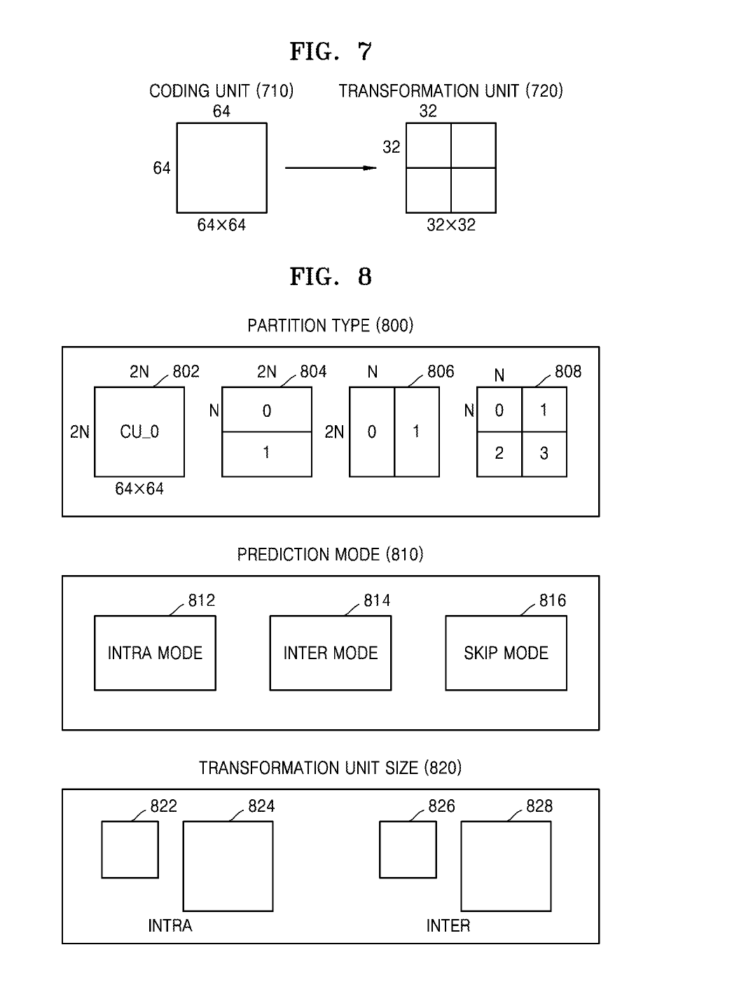

FIG. 7 is a diagram for describing a relationship between a coding unit 710 and transformation units 720, according to an embodiment of the present invention.

The video encoding apparatus 100 according to an embodiment or the video decoding apparatus 200 according to an embodiment encodes or decodes an image according to coding units having sizes smaller than or equal to a maximum coding unit for each maximum coding unit. Sizes of transformation units for frequency transformation during encoding may be selected based on data units that are not larger than a corresponding coding unit.

For example, in the video encoding apparatus 100 according to an embodiment or the video decoding apparatus 200 according to an embodiment, if a size of the current coding unit 710 is 64×64, transformation may be performed by using the transformation units 720 having a size of 32×32.

Also, data of the coding unit 710 having the size of 64×64 may be encoded by performing the transformation on each of the transformation units having the size of 32×32, 16×16, 8×8, and 4×4, which are smaller than 64×64, and then a transformation unit having a least error may be selected.

FIG. 8 is a diagram for describing encoding information of coding units corresponding to a coded depth, according to an embodiment of the present invention.

The output unit 130 of the video encoding apparatus 100 according to an embodiment may encode and transmit information 800 about a partition type, information 810 about a prediction mode, and information 820 about a size of a transformation unit for each coding unit corresponding to a coded depth, as information about an encoding mode.

The information 800 about the partition type indicates information about a shape of a partition obtained by splitting a prediction unit of a current coding unit, wherein the partition is a data unit for prediction encoding the current coding unit. For example, a current coding unit CU_{—}0 having a size of 2N×2N may be split into any one of a partition 802 having a size of 2N×2N, a partition 804 having a size of 2N×N, a partition 806 having a size of N×2N, and a partition 808 having a size of N×N. Here, the information 800 about the partition type of the current coding unit is set to indicate one of the partition 804 having a size of 2N×N, the partition 806 having a size of N×2N, and the partition 808 having a size of N×N

The information 810 about the prediction mode indicates a prediction mode of each partition. For example, the information 810 about the prediction mode may indicate a mode of prediction encoding performed on a partition indicated by the information 800, i.e., an intra mode 812, an inter mode 814, or a skip mode 816.

Also, the information 820 about the size of the transformation unit indicates a transformation unit to be based on when frequency transformation is performed on a current coding unit. For example, the transformation unit may be a first intra transformation unit 822, a second intra transformation unit 824, a first inter transformation unit 826, or a second intra transformation unit 828.

The image data and encoding information extractor 220 of the video decoding apparatus 200 according to an embodiment may extract and use the information 800 about the partition type, the information 810 about the prediction mode, and the information 820 about the size of the transformation unit for decoding according to each deeper coding unit

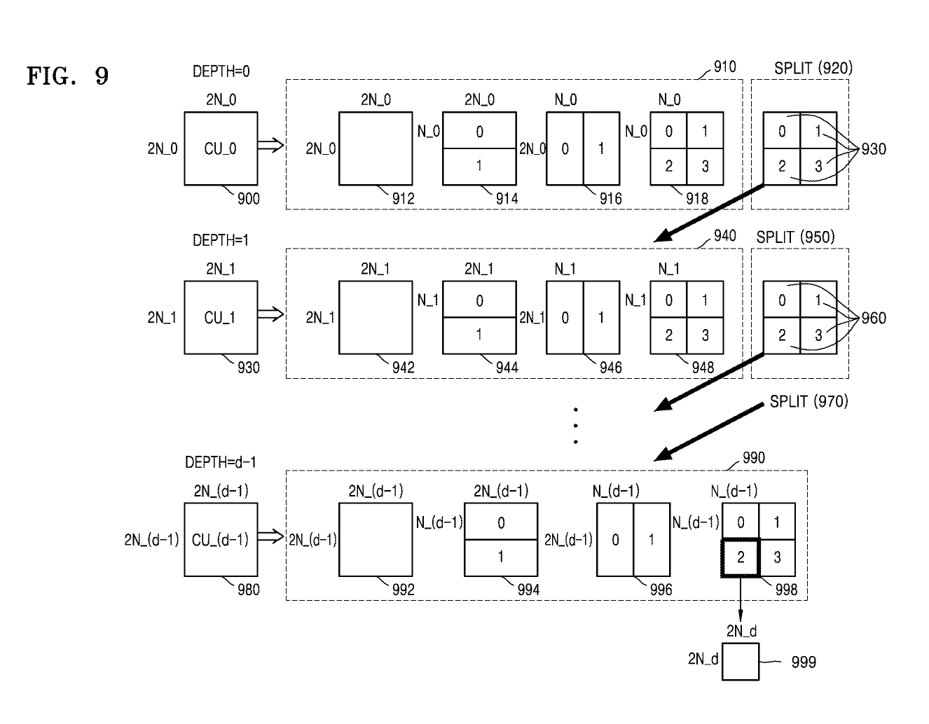

FIG. 9 is a diagram of deeper coding units according to depths according to an embodiment of the present invention.

Split information may be used to indicate a change of a depth. The spilt information indicates whether a coding unit of a current depth is split into coding units of a lower depth.

A prediction unit 910 for prediction encoding a coding unit 900 having a depth of 0 and a size of 2N_{—}0×2N_{—}0 may include partitions of a partition type 912 having a size of 2N_{—}0×2N_{—}0, a partition type 914 having a size of 2N_{—}0×N_{—}0, a partition type 916 having a size of N_{—}0×2N_{—}0, and a partition type 918 having a size of N_{—}0×N_{—}0. FIG. 9 only illustrates the partition types 912 through 918 which are obtained by symmetrically splitting the prediction unit 910, but a partition type is not limited thereto, and the partitions of the prediction unit 910 may include asymmetrical partitions, partitions having a predetermined shape, and partitions having a geometrical shape.

Prediction encoding has to be repeatedly performed on one partition having a size of 2N_{—}0×2N_{—}0, two partitions having a size of 2N_{—}0×N_{—}0, two partitions having a size of N_{—}0×2N_{—}0, and four partitions having a size of N_{—}0×N_{—}0, according to each partition type. The prediction encoding in an intra mode and an inter mode may be performed on the partitions having the sizes of 2N_{—}0×2N_{—}0, N_{—}0×2N_{—}0, 2N_{—}0×N_{—}0, and N_{—}0×N_{—}0. The prediction encoding in a skip mode may be performed only on the partition having the size of 2N_{—}0×2N_{—}0.

If an encoding error is smallest in one of the partition types 912 through 916 having the sizes of 2N_{—}0×2N_{—}0, 2N_{—}0×N_{—}0, and N_{—}0×2N_{—}0, the prediction unit 910 may be no longer split to a lower depth.

If the encoding error is the smallest in the partition type 918 having the size of N_{—}0×N_{—}0, a depth may be changed from 0 to 1 to split the partition type 918 in operation 920, and encoding may be repeatedly performed on coding units 930 having a depth of 2 and a size of N_{—}0×N_{—}0 to search for a least encoding error.

A prediction unit 940 for prediction encoding the coding unit 930 having a depth of 1 and a size of 2N_{—}1×2N_{—}1 (=N_{—}0×N_{—}0) may include partitions of a partition type 942 having a size of 2N_{—}1×2N_{—}1, a partition type 944 having a size of 2N_{—}1×N_{—}1, a partition type 946 having a size of N_{—}1×2N_{—}1, and a partition type 948 having a size of N_{—}1×N_{—}1.

If an encoding error is the smallest in the partition type 948 having the size of N_{—}1×N_{—}1, a depth may be changed from 1 to 2 to split the partition type 948 in operation 950, and encoding may be repeatedly performed on coding units 960, which have a depth of 2 and a size of N_{—}2×N_{—}2 to search for a least encoding error.

When a maximum depth is d, split information according to each depth may be set until a depth becomes d−1, and split information may be set until a depth becomes d−2. In other words, when encoding is performed until the depth is d−1 after a coding unit corresponding to a depth of d−2 is split in operation 970, a prediction unit 990 for prediction encoding a coding unit 980 having a depth of d−1 and a size of 2N_(d−1)×2N_(d−1) may include partitions of a partition type 992 having a size of 2N_(d−1)×2N_(d−1), a partition type 994 having a size of 2N_(d−1)×N_(d−1), a partition type 996 having a size of N_(d−1)×2N_(d−1), and a partition type 998 having a size of N_(d−1)×N_(d−1).

Prediction encoding may be repeatedly performed on one partition having a size of 2N_(d−1)×2N_(d−1), two partitions having a size of 2N_(d−1)×N_(d−1), two partitions having a size of N_(d−1)×2N_(d−1), four partitions having a size of N_(d−1)×N_(d−1) from among the partition types 992 through 998 to search for a partition type having a least encoding error.

Even when the partition type 998 having the size of N_(d−1)×N_(d−1) has the least encoding error, since a maximum depth is d, a coding unit CU_(d−1) having a depth of d−1 may be no longer split to a lower depth, a coded depth for a current maximum coding unit 900 may be determined to be d−1, and a partition type of the current maximum coding unit 900 may be determined to be N_(d−1)×N_(d−1). Also, since the maximum depth is d, split information for a coding unit 952 having a depth of d−1 is not set.

A data unit 999 may be referred to as a ‘minimum unit’ for the current maximum coding unit. A minimum unit according to an embodiment may be a rectangular data unit obtained by splitting a minimum coding unit having a lowermost coded depth by 4. By performing the encoding repeatedly, the video encoding apparatus 100 may select a depth having a least encoding error by comparing encoding errors according to depths of the coding unit 900 to determine a coded depth, and may set a corresponding partition type and a prediction mode as an encoding mode of the coded depth.

As such, the least encoding errors according to depths are compared in all of the depths of 1 through d, and a depth having the least encoding error may be determined as a coded depth. The coded depth, the partition type of the prediction unit, and the prediction mode may be encoded and transmitted as information about an encoding mode. Also, since a coding unit has to be split from a depth of 0 to the coded depth, only split information of the coded depth has to be set to 0, and split information of depths excluding the coded depth has to be set to 1.

The image data and encoding information extractor 220 of the video decoding apparatus 200 according to an embodiment may extract and use the information about the coded depth and the prediction unit of the coding unit 900 to decode the coding unit 912. The video decoding apparatus 200 according to an embodiment may determine a depth, in which split information is 0, as a coded depth by using split information according to depths, and may use information about an encoding mode of the corresponding depth for decoding.

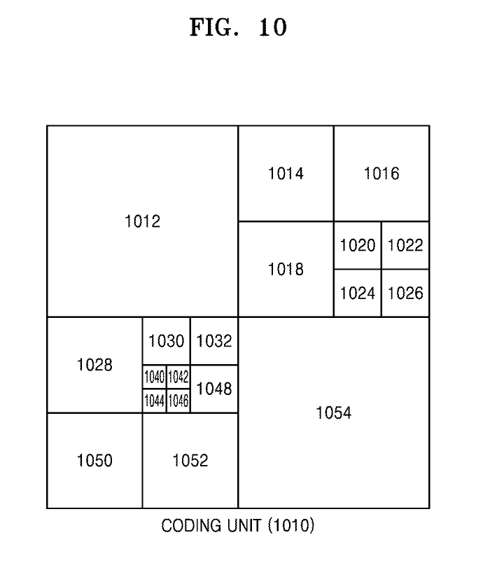

FIGS. 10 through 12 are diagrams for describing a relationship between coding units 1010, prediction units 1060, and frequency transformation units 1070, according to an embodiment of the present invention.

The coding units 1010 are coding units corresponding to coded depths determined by the video encoding apparatus 100 according to an embodiment, in a maximum coding unit. The prediction units 1060 are partitions of prediction units of each of the coding units 1010, and the transformation units 1070 are transformation units of each of the coding units 1010.

When a depth of a maximum coding unit is 0 in the coding units 1010, depths of coding units 1012 and 1054 are 1, depths of coding units 1014, 1016, 1018, 1028, 1050, and 1052 are 2, depths of coding units 1020, 1022, 1024, 1026, 1030, 1032, and 1048 are 3, and depths of coding units 1040, 1042, 1044, and 1046 are 4.

In the prediction units 1060, some partitions 1014, 1016, 1022, 1032, 1048, 1050, 1052, and 1054 are obtained by splitting the coding units. In other words, partition types in the partitions 1014, 1022, 1050, and 1054 have a size of 2N×N, partition types in the partitions 1016, 1048, and 1052 have a size of N×2N, and a partition type of the partition 1032 has a size of N×N. Prediction units and partitions of the coding units 1010 are smaller than or equal to each coding unit.

Frequency transformation or inverse frequency transformation is performed on image data of the transformation unit 1052 in the transformation units 1070 in a data unit that is smaller than the transformation unit 1052. Also, the transformation units 1014, 1016, 1022, 1032, 1048, 1050, and 1052 in the transformation units 1070 are different from those in the prediction units 1060 in terms of sizes or shapes. In other words, the video encoding apparatus 100 according to an embodiment and the video decoding apparatus 200 according to an embodiment may perform intra prediction/motion estimation/motion compensation, and frequency transformation/inverse frequency transformation individually on a data unit even in the same coding unit.

Accordingly, encoding may be recursively performed on each of coding units having a hierarchical structure in each region of a maximum coding unit to determine an optimum coding unit, and thus coding units having a recursive tree structure may be obtained. Encoding information may include split information about a coding unit, information about a partition type, information about a prediction mode, and information about a size of a transformation unit. Table 1 shows the encoding information that may be set by the video encoding apparatus 100 according to an embodiment and the video decoding apparatus 200 according to an embodiment.

TABLE 1

| Split Information 0 | | | | | |
|---|---|---|---|---|---|
| (Encoding on Coding Unit having Size of 2N × 2N and Current Depth of d) | | | | | |
| | | | Size of Transformation Unit | | |
| | | | Split | Split | |
| | Partition Type | | Information 0 | Information 1 | |
| | Symmetrical | | of | of | |
| Prediction | Partition | Asymmetrical | Transformation | Transformation | Split |
| Mode | Type | Partition Type | Unit | Unit | Information 1 |
| Intra | 2N × 2N | 2N × nU | 2N × 2N | N × N | Repeatedly |
| Inter | 2N × N | 2N × nD | | (Symmetrical | Encode |
| Skip (Only | N × 2N | nL × 2N | | Type) | Coding Units |
| 2N × 2N) | N × N | nR × 2N | | N/2 × N/2 | having Lower |
| | | | | (Asymmetrical | Depth of |
| | | | | Type) | d + 1 |

The output unit 130 of the video encoding apparatus 100 according to an embodiment may output the encoding information about the coding units having the tree structure, and the image data and encoding information extractor 220 of the video decoding apparatus 200 according to an embodiment may extract the encoding information about the coding units having the tree structure from a received bitstream.

Split information indicates whether a current coding unit is split into coding units of a lower depth. If split information of a current depth d is 0, a depth, in which a current coding unit is no longer split to a lower depth, is a coded depth, and thus information about a partition type, a prediction mode, and a size of a transformation unit may be defined for the coded depth. If the current coding unit is further split according to the split information, encoding has to be independently performed on four split coding units of a lower depth.

A prediction mode may be one of an intra mode, an inter mode, and a skip mode. The intra mode and the inter mode may be defined in all partition types, and the skip mode may be defined only in a partition type having a size of 2N×2N.

The information about the partition type may indicate symmetrical partition types having sizes of 2N×2N, 2N×N, N×2N, and N×N, which are obtained by symmetrically splitting a height or a width of a prediction unit, and asymmetrical partition types having sizes of 2N×nU, 2N×nD, nL×2N, and nR×2N, which are obtained by asymmetrically splitting the height or width of the prediction unit. The asymmetrical partition types having the sizes of 2N×nU and 2N×nD are respectively obtained by splitting the height of the prediction unit in 1:3 and 3:1, and the asymmetrical partition types having the sizes of nL×2N and nR×2N are respectively obtained by splitting the width of the prediction unit in 1:3 and 3:1

The size of the transformation unit may be set to be two types in the intra mode and two types in the inter mode. In other words, if split information of the transformation unit is 0, the size of the transformation unit is set to 2N×2N, which is the size of the current coding unit. If split information of the transformation unit is 1, the transformation units may be obtained by splitting the current coding unit. Also, if a partition type of the current coding unit having the size of 2N×2N is a symmetrical partition type, a size of a transformation unit may be set to N×N, and if the partition type of the current coding unit is an asymmetrical partition type, the size of the transformation unit may be set to N/2×N/2.

The encoding information about coding units having a tree structure, according to an embodiment, may be assigned to at least one of a coding unit corresponding to a coded depth, a prediction unit, and a minimum unit. The coding unit corresponding to the coded depth may include at least one of a prediction unit and a minimum unit containing the same encoding information.

Accordingly, it is determined whether adjacent data units are included in the same coding unit corresponding to the coded depth by comparing encoding information of the adjacent data units. Also, a corresponding coding unit corresponding to a coded depth may be determined by using encoding information of a data unit, and thus a distribution of coded depths in a maximum coding unit may be determined.

Accordingly, if a current coding unit is predicted by referring to adjacent data units, encoding information of data units in deeper coding units adjacent to the current coding unit may be directly referred to and used.

Alternatively, if a current coding unit is prediction encoded by referring to adjacent data units, data units adjacent to the current coding unit in deeper coding units may be searched for by using encoded information of the data units, and the searched adjacent coding units may be referred to for prediction encoding the current coding unit.

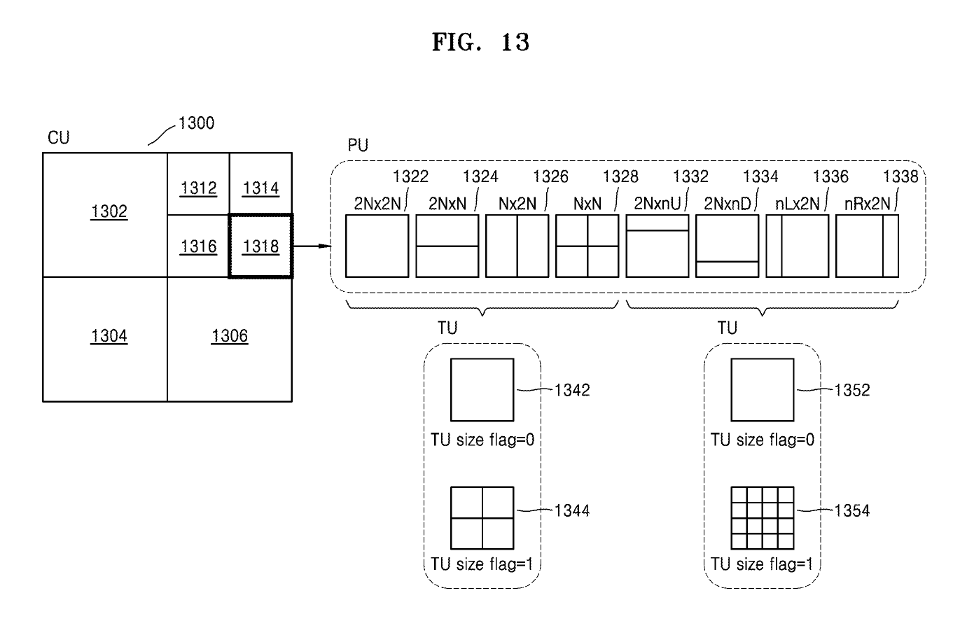

FIG. 13 is a diagram for describing a relationship between a coding unit, a prediction unit, and a transformation unit, according to the encoding mode information of Table 1.

A maximum coding unit 1300 includes coding units 1302, 1304, 1306, 1312, 1314, 1316, and 1318 of coded depths. Here, since the coding unit 1318 is a coding unit of a coded depth, split information may be set to 0. Information about a partition type of the coding unit 1318 having a size of 2N×2N may be set to be one of a partition type 1322 having a size of 2N×2N, a partition type 1324 having a size of 2N×N, a partition type 1326 having a size of N×2N, a partition type 1328 having a size of N×N, a partition type 1332 having a size of 2N×nU, a partition type 1334 having a size of 2N×nD, a partition type 1336 having a size of nL×2N, and a partition type 1338 having a size of nR×2N.

Split information (TU (Transformation Unit)size flag) of a transformation unit is a type of a transformation index. The size of the transformation unit corresponding to the transformation index may be changed according to a prediction unit type or partition type of the coding unit.

For example, when the partition type is set to be symmetrical, i.e. the partition type 1322, 1324, 1326, or 1328, a transformation unit 1342 having a size of 2N×2N is set if split information (TU size flag) of a transformation unit is 0, and a transformation unit 1344 having a size of N×N is set if a TU size flag is 1.

When the partition type is set to be asymmetrical, i.e., the partition type 1332, 1334, 1336, or 1338, a transformation unit 1352 having a size of 2N×2N is set if a TU size flag is 0, and a transformation unit 1354 having a size of N/2×N/2 is set if a TU size flag is 1.

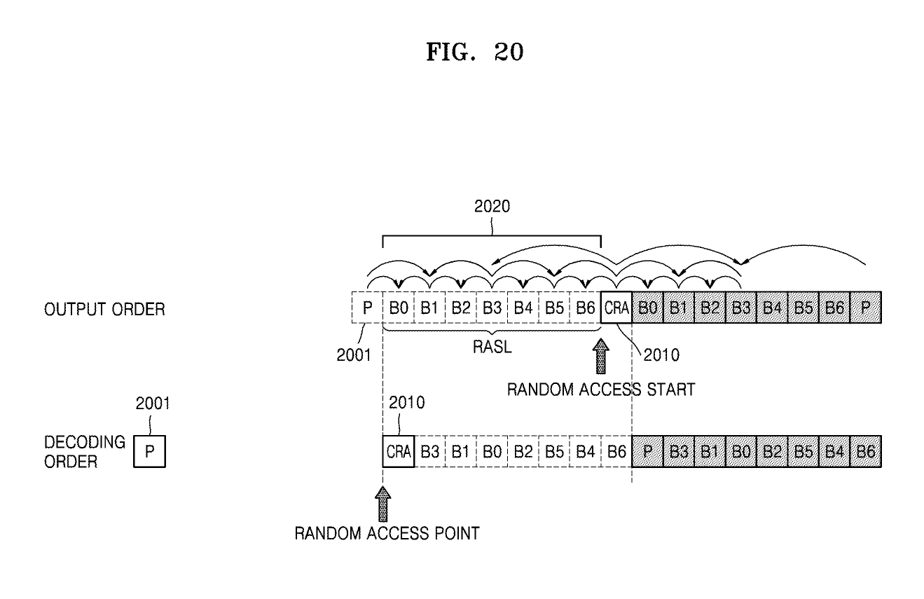

Referring to FIG. 20, the TU size flag is a flag having a value or 0 or 1, but the TU size flag is not limited to 1 bit, and a transformation unit may be hierarchically split having a tree structure while the TU size flag increases from 0. Split information (TU size flag) of a transformation unit may be an example of a transformation index.

In this case, the size of a transformation unit that has been actually used may be expressed by using a TU size flag of a transformation unit, according to an exemplary embodiment, together with a maximum size and minimum size of the transformation unit. According to an exemplary embodiment, the video encoding apparatus 100 is capable of encoding maximum transformation unit size information, minimum transformation unit size information, and a maximum TU size flag. A result of encoding the maximum transformation unit size information, the minimum transformation unit size information, and the maximum TU size flag may be inserted into an SPS. According to an exemplary embodiment, the video decoding apparatus 200 may decode video by using the maximum transformation unit size information, the minimum transformation unit size information, and the maximum TU size flag.

For example, (a) if the size of a current coding unit is 64×64 and a maximum transformation unit size is 32×32, (a−1) then the size of a transformation unit may be 32×32 when a TU size flag is 0, (a−2) may be 16×16 when the TU size flag is 1, and (a−3) may be 8×8 when the TU size flag is 2.

As another example, (b) if the size of the current coding unit is 32×32 and a minimum transformation unit size is 32×32, (b−1) then the size of the transformation unit may be 32×32 when the TU size flag is 0. Here, the TU size flag cannot be set to a value other than 0, since the size of the transformation unit cannot be less than 32×32.

As another example, (c) if the size of the current coding unit is 64×64 and a maximum TU size flag is 1, then the TU size flag may be 0 or 1. Here, the TU size flag cannot be set to a value other than 0 or 1.

Thus, if it is defined that the maximum TU size flag is ‘MaxTransformSizeIndex’, a minimum transformation unit size is ‘MinTransformSize’, and a transformation unit size is ‘RootTuSize’ when the TU size flag is 0, then a current minimum transformation unit size ‘CurrMinTuSize’ that can be determined in a current coding unit, may be defined by Equation (1):

CurrMinTuSize=max(MinTransformSize,RootTuSize/(2̂MaxTransformSizeIndex)) (1)

Compared to the current minimum transformation unit size ‘CurrMinTuSize’ that can be determined in the current coding unit, a transformation unit size ‘RootTuSize’ when the TU size flag is 0 may denote a maximum transformation unit size that can be selected in the system. In Equation (1), ‘RootTuSize/(2̂MaxTransformSizeIndex)’ denotes a transformation unit size when the transformation unit size ‘RootTuSize’, when the TU size flag is 0, is split a number of times corresponding to the maximum TU size flag, and ‘MinTransformSize’ denotes a minimum transformation size. Thus, a smaller value from among ‘RootTuSize/(2̂MaxTransformSizeIndex)’ and ‘MinTransformSize’ may be the current minimum transformation unit size ‘CurrMinTuSize’ that can be determined in the current coding unit.

According to an exemplary embodiment, the maximum transformation unit size RootTuSize may vary according to the type of a prediction mode.

For example, if a current prediction mode is an inter mode, then ‘RootTuSize’ may be determined by using Equation (2) below. In Equation (2), ‘MaxTransformSize’ denotes a maximum transformation unit size, and ‘PUSize’ denotes a current prediction unit size.

RootTuSize=min(MaxTransformSize,PUSize) (2)

That is, if the current prediction mode is the inter mode, the transformation unit size ‘RootTuSize’, when the TU size flag is 0, may be a smaller value from among the maximum transformation unit size and the current prediction unit size.

If a prediction mode of a current partition unit is an intra mode, ‘RootTuSize’ may be determined by using Equation (3) below. In Equation (3), ‘PartitionSize’ denotes the size of the current partition unit.

RootTuSize=min(MaxTransformSize,PartitionSize) (3)

That is, if the current prediction mode is the intra mode, the transformation unit size ‘RootTuSize’ when the TU size flag is 0 may be a smaller value from among the maximum transformation unit size and the size of the current partition unit.

However, the current maximum transformation unit size ‘RootTuSize’ that varies according to the type of a prediction mode in a partition unit is just an example and the present invention is not limited thereto.

The maximum coding unit including the coding units having the tree structure described with reference to FIGS. 1 through 13 above is variously named as a coding block tree, a block tree, a root block tree, a coding tree, a coding root, or a tree trunk.

As described above, the video encoding apparatus 100 and the video decoding apparatus 200 according to an exemplary embodiment performs encoding and decoding according to coding units having sizes smaller than or equal to a maximum coding unit for each maximum coding unit by splitting the maximum coding unit. Data encoded by the video encoding apparatus 100 is multiplexed by using a transmission data unit suitable for a protocol used by a communication channel, storage media, a video editing system, a media framework, etc. or a format. The transmission data unit is transmitted to the video decoding apparatus 200. According to an exemplary embodiment, a network adaptive layer (NAL) unit is used as the transmission data unit.

Hereinafter, a method and apparatus for generating a NAL unit bitstream including encoding information with respect to a random access point (RAP) picture for random access and a method and apparatus for decoding video based on the NAL unit bitstream including the encoding information with respect to the RAP picture will be described with reference to FIGS. 14 through 27. A decoding order and an encoding order means a picture processing order with respect to a decoding side and an encoding side, respectively. A picture encoding order is the same as a picture decoding order. Thus, the encoding order may mean the decoding order in the description of the present invention, and the decoding order may also mean the encoding order.

FIG. 14 is a diagram for explaining a hierarchical classification of video encoding and decoding processes according to an embodiment of the present invention.

Referring to FIG. 14, the video encoding and decoding processes may include encoding and decoding processes performed in a video coding layer (VCL) 1410 that processes video encoding itself and encoding and decoding processes performed by an NAL 1420 that generates or receives encoded image data and additional information to a bitstream having a predetermined format between a subordinate system 1430 that transmits and stores the encoded image data and the VCL 1410. Encoding data 1411 regarding an encoded image of the VCL 1410 is mapped to a VCL NAL unit 1421. Parameter set additional information 1412 for decoding of the encoding data 1411 is mapped to a non-VCL NAL unit 1422. The VCL NAL unit 1421 and the non-VCL NAL unit 1422 may be referred to as a bitstream 1431. Information regarding which information is included in a corresponding NAL unit may be included in a header of the VCL NAL unit 1421 and a header of the non-VCL NAL unit 1422. In particular, as will be described later, information indicating a type of a picture included in a NAL unit may be included in the header of the VCL NAL unit 1421.

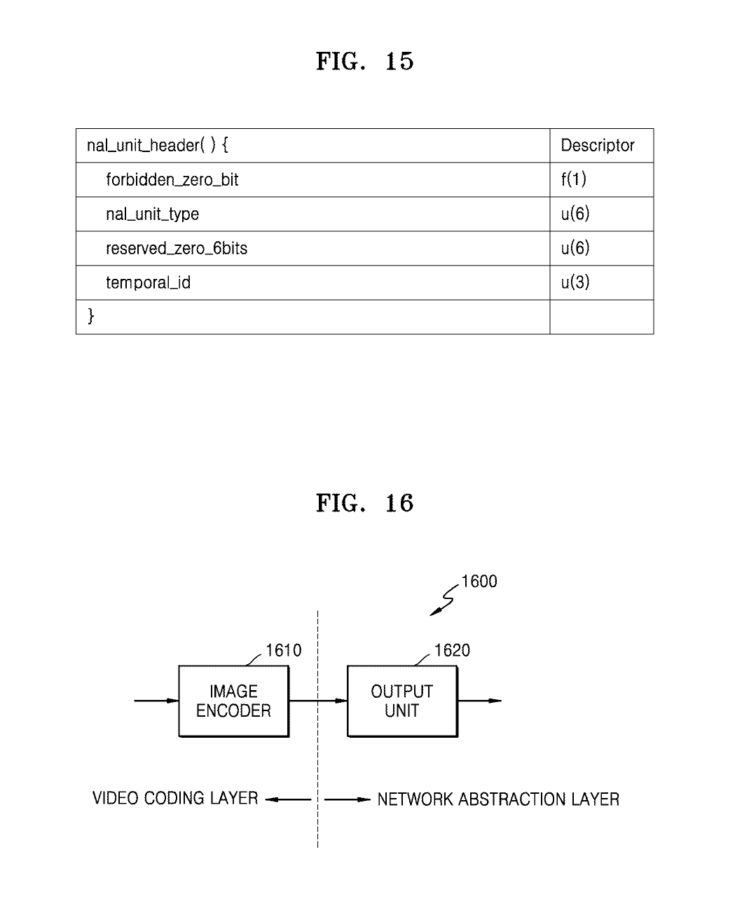

FIG. 15 illustrates an example of a header of a NAL unit according to an embodiment of the present invention.

Referring to FIG. 15, the header of the NAL unit has a total length of 2 bytes. The header of the NAL unit includes forbidden_zero_bit having “0” as a bit for identifying the NAL unit, an ID NAL unit type (NUT) indicating a type of the NAL unit, and a region reserved_zero_{—}6 bits reserved for a future use, and a temporal ID temporal_id. Each of the ID NUT and the region reserved_zero_{—}6 bits reserved for the future use includes 6 bits. The temporal ID temporal_id may include 3 bits.

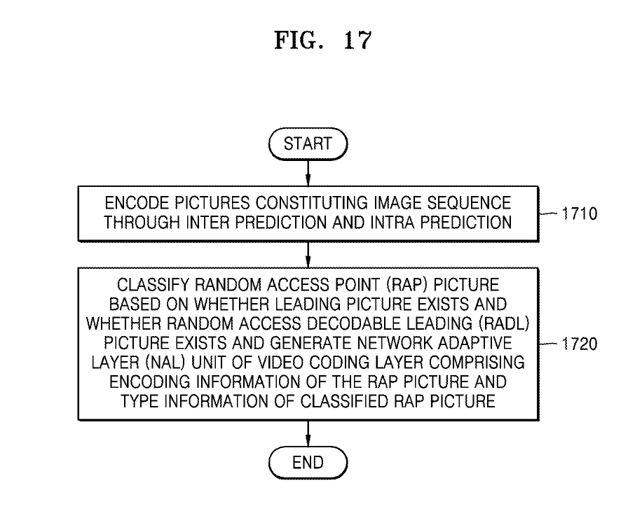

FIG. 16 is a block diagram of a video encoding apparatus 1600 according to an exemplary embodiment of the present invention. FIG. 17 is a flowchart of a video decoding method according to an exemplary embodiment of the present invention.

Referring to FIGS. 16 and 17, the video encoding apparatus 1600 according to an embodiment of the present invention includes an image encoder 1610 and an output unit 1620.

The image encoder 1610 corresponds to a video coding layer. The output unit 1620 corresponds to a network abstraction layer (NAL) that adds and outputs encoded video data and additional information to a NAL unit.

In more detail, in operation S1710, the image encoder 1610 performs prediction encoding on each picture constituting a video sequence by using coding units according to a tree structure like the image encoder 400 of FIG. 4 described above. The image encoder 1610 encodes pictures by performing inter prediction and intra prediction and outputs residual data and information regarding a motion vector and a prediction mode.

The output unit 1620 generates and outputs the NAL unit including encoded video data and additional information. In particular, in operation S1720, the output unit 1620 classifies RAP pictures based on whether leading pictures, which precede the RAP pictures in an output order but are decoded after the RAP pictures for random access in a decoding order of a decoder, exist and whether a random access decodable leading (RADL) picture exists among the leading pictures, and generates a NAL unit of a VCL including encoding information of the RAP pictures and type information of the classified RAP pictures.

In general, when the video encoding apparatus 1600 reproduces video data, the video encoding apparatus 1600 may reconstruct and reproduce the video data by using one of a trick play method and a normal play method. The trick play method includes a fast forward method, a fast backward method, and a random access method. The normal play method is a method of sequentially reproducing all pictures included in video data. The fast forward method or the fast backward method is a method of selecting and reproducing forward or backward an RAP picture every predetermined cycle according to a reproduction speed. The random access method is a method of skipping and reproducing an RAP picture of a predetermined location. According to the H.264/AVC standard, only an instantaneous decoder refresh (IDR) is used as an RAP picture for random access. The IDR picture is an intra picture in which a buffer of a decoding apparatus is refreshed at the instant that the IDR picture is decoded. In more detail, at the instant that the IDR picture is decoded, a decoded picture buffer (DPB) marks a previously decoded picture, excluding the IDR picture, as a picture that is not any longer referred to, and a picture order count (POC) is also initialized. A picture decoded after the IDR picture is always after the IDR picture in an output order, and is decoded without referring to a picture prior to the IDR picture.

According to an exemplary embodiment, a clean random access (CRA) picture and a broken link access (BLA) picture are used as an RAP picture for random access, other than the IDR picture. A temporal sublayer access (TSA) picture and a stepwise temporal sublayer access (STSA) picture are used to support temporal scalability. The IDR picture, the CRA picture, the BLA picture, the TSA picture, and the STSA picture will be described later.

As described above, the reason why various RAP pictures are used for the random access, other than the IDR picture, is that prediction efficiency of the IDR picture is low since the IDR picture is limited to a coding structure known as a closed group of pictures (GOP). As described above, the picture decoded after the IDR picture may not refer to the picture prior to the IDR picture. As such, a coding structure in which the picture prior to the IDR picture is not referred to is referred to as the closed GOP. To improve prediction efficiency, a leading picture, which is a picture that is output after the RAP picture in an output order (a display order) but is decoded after the RAP picture, may be allowed to refer to the picture decoded prior to the RAP picture without being limited to a reference picture. A coding structure in which the picture decoded prior to the RAP picture is allowed as the reference picture is referred to as an open GOP. Compared to a case where the IDR picture to which the reference picture is limited is used, a new type of an RAP picture using the open GOP is defined, thereby improving prediction efficiency.

In order for a video decoding apparatus to identify which type of information a picture included in a current NAL unit is, the video encoding apparatus 1600 according to an exemplary embodiment may allow a NAL unit header to include type information indicating information regarding which type of picture is included in the current NAL unit. In particular, the video encoding apparatus 1600 classifies the IDR pictures, the BLA pictures, and the CLA pictures which are RAP pictures for the random access based on whether leading pictures exist and whether an RADL picture exists among the leading pictures, and adds type information of the classified RAP pictures to the NAL unit header.

A method of classifying the IDR picture, the BLA picture, and the CLA picture which are RAP pictures for the random access will now be described below.

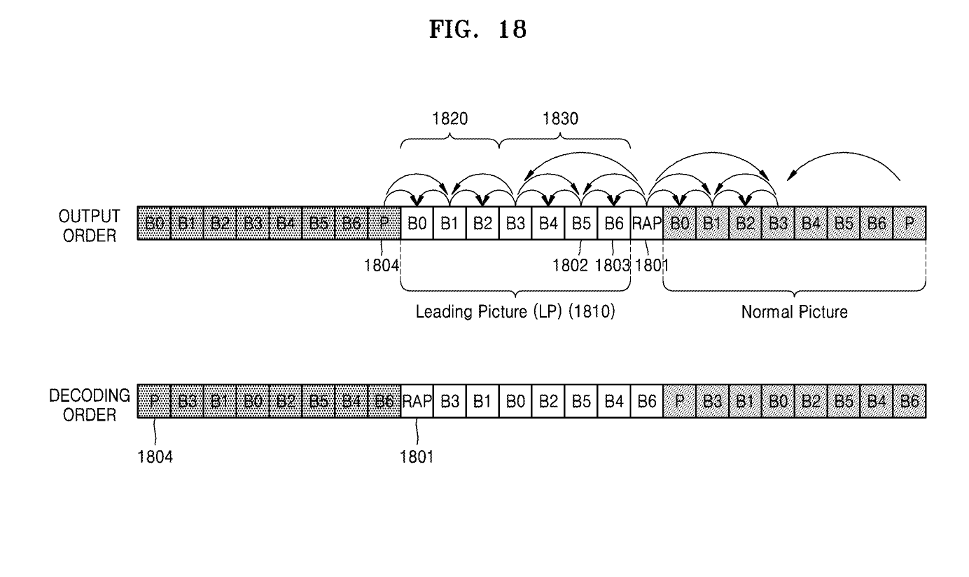

FIG. 18 is a reference view for explaining a leading picture according to an exemplary embodiment of the present invention.

The leading picture is a picture that is decoded after an RAP picture in a decoding order but is output prior to the RAP picture in an output order. A picture that is decoded and output after an RAP picture in the decoding order and the output order is defined as a normal picture or a trailing picture.

Referring to FIG. 18, B0 through B6 pictures 1810 are leading pictures that are decoded after an RAP picture 1801 in a decoding order but precede the RAP picture 1801 in an output order. In FIG. 18, an arrow direction is assumed as a reference direction. For example, a B6 picture 1803 uses a B5 picture 1802 and an RAP picture 1801 as reference pictures. When random access starts from the RAP picture 1801 again, leading pictures are classified as a random access decodable leading (RADL) picture and a random access skipped leading (RASL) picture according to whether decoding is possible. In FIG. 18, since B0 through B2 pictures 1820 may be predicted based on a P picture 1804 that is received and decoded prior to the RAP picture 1801, so when the random access starts from the RAP picture 1801, the B0 through B2 pictures 1820 are pictures that may not be normally decoded. Like the B0 through B2 pictures 1820, when the random access starts from the RAP picture 1801, a leading picture that may not be normally decoded is defined as an RASL picture. Meanwhile, since B3 through B6 pictures 1830 use only pictures decoded after the RAP picture 1801 as reference pictures, even when the random access starts from the RAP picture 1801, the B3 through B6 pictures 1830 are pictures that may not be normally decoded. Like the B3 through B6 pictures 1830, when the random access starts from the RAP picture 1801, a picture that may not be normally decoded is defined as an RADL picture.

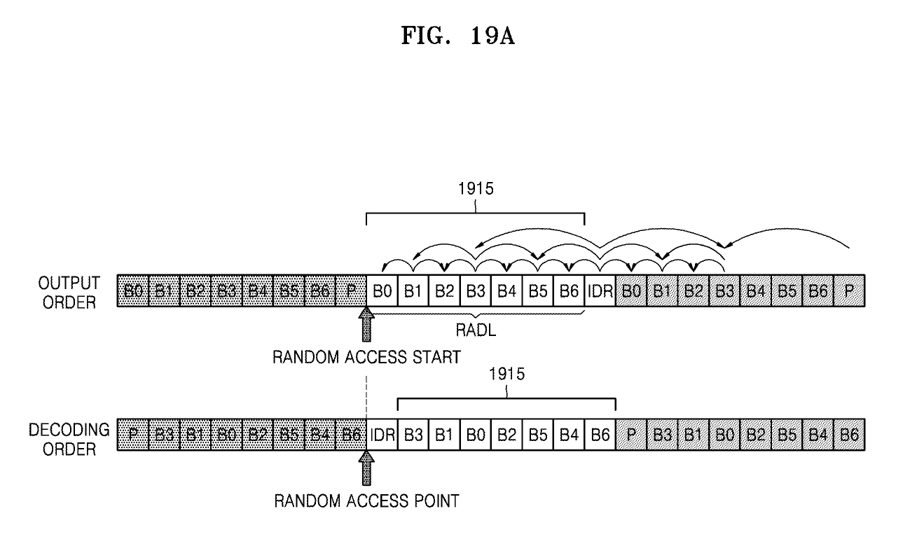

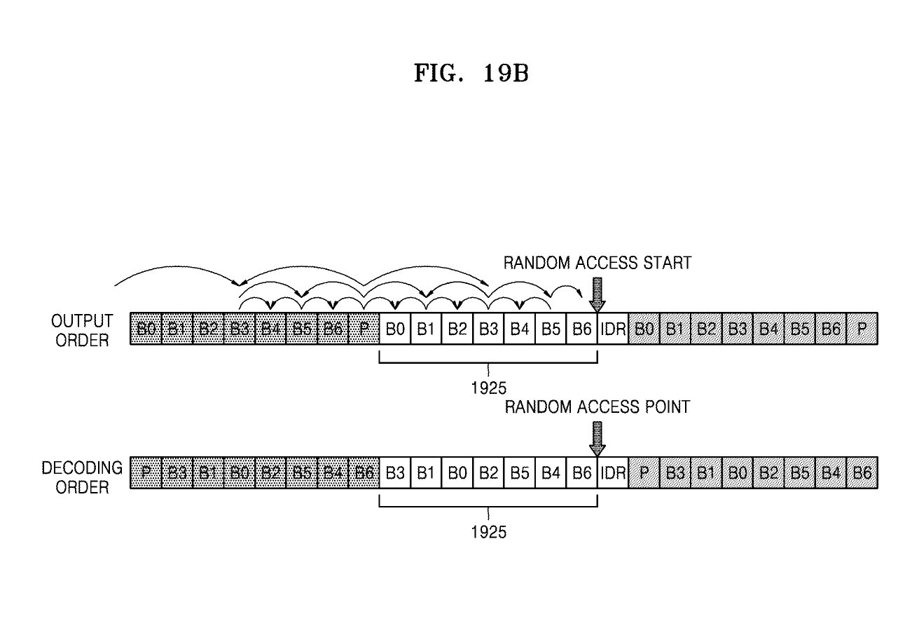

FIGS. 19A and 19B are reference views for explaining an IDR picture according to an exemplary embodiment of the present invention.

As described above, the IDR picture initializes a decoded picture buffer (DPB) and a POC at the instant that the IDR picture is decoded, and a picture decoded after the IDR picture is always behind the IDR picture in an output order and is decoded without referring to a picture prior to the IDR picture. However, the IDR picture follows a closed GOP structure in which leading pictures are limited to use a picture decoded prior to the IDR picture as a reference picture. Thus, the IDR picture may be classified as two types of IDR pictures based on whether a leading picture exists and whether an RADL picture exists. In more detail, IDR pictures may be classified as two types of i) an IDR picture IDR_N_LP having no leading picture and ii) an IDR picture IDR_W_LP having an RADL picture that is a decodable leading picture.

FIG. 19A shows the IDR picture IDR_W_LP having the RADL picture that is the decodable leading picture. Referring to FIG. 19A, B0 through B6 pictures 1915 are leading pictures that precede prior to the IDR picture in an output order but are decoded after the IDR picture in a decoding order. Since pictures decoded after the IDR picture do not use a picture decoded prior to the IDR picture as a reference picture, all leading pictures of the IDR picture correspond to RADL pictures decodable at a random access time.

FIG. 19B shows the IDR picture IDR_N_LP having no leading picture. Referring to FIG. 19B, unlike FIG. 19A described above, B0 through B6 pictures 1925 refer to only a picture decoded prior to the IDR picture, and the IDR picture has no leading picture. As described above, IDR pictures may be classified as two types of i) the IDR picture IDR_N_LP having no leading picture and ii) the IDR picture IDR_W_LP having an RADL picture that is a decodable leading picture.

A CRA picture, which is an I picture, initializes a DPB at the instant that the CRA picture is decoded similar to the IDR picture. Normal pictures that follow CRA picture in both a decoding order and an output order may not refer to a picture prior to the CRA picture. However, the IDR picture follows a closed GOP structure in which leading pictures are limited to using a picture decoded prior to the IDR picture as a reference picture, whereas the CRA picture allows a leading picture to use a picture decoded prior to the CRA picture as a reference picture. That is, in the CRA picture, a picture referring to a picture decoded prior to the CRA picture may exist among leading pictures that are pictures following the CRA picture in the decoding order but preceding the CRA picture in an output order. When random access starts from the CRA picture, since some leading pictures use a reference picture that may not be used at a random access point, they may not be decoded.

Thus, CRA pictures may be classified as i) a CRA picture CRA_N_LP having no leading picture, ii) a CRA picture CRA_W_RADL having a RADL picture, and iii) a CRA picture CRA_W_RASL having an RASL picture. The reason why CRA pictures are classified as described above is that when the CRA picture has an RASL picture, the RASL picture may be discarded without being decoded during the random access. A decoding apparatus may previously determine whether an RASL picture of which decoding is not necessary at a decoding time exists, and, when receiving an NAL unit bitstream including the RASL picture, may skip an unnecessary decoding process on a corresponding RASL picture.

FIG. 20 shows a CRA picture CRA_W_RASL having an RASL picture.

Referring to FIG. 20, since random access starts from a CRA picture 2010, a P picture 20001 that precedes the CRA picture 2010 in a decoding order is not decoded. Thus, pictures that use the P picture 2001 as a reference picture or pictures that use, as a reference picture, a picture that uses the P picture 2001 as the reference picture, for example, B0 through B6 pictures 2020, are RASL pictures that may not be decodable during the random access.

When not limited to an example of FIG. 20, and some leading pictures of a CRA picture are RASL pictures, the CRA picture is the CRA picture CRA_W_RASL having the RASL picture. Similarly to the IDR picture IDR_W_RADL having the RASL picture of FIG. 19A described above, when leading pictures of the CRA picture are RADL pictures, the CRA picture is a CRA picture CRA_W_RADL having a leading picture. Similarly to the IDR picture IDR_N_LP having a leading picture of FIG. 19B described above, when no leading picture of the CRA picture exists, the CRA picture is a CRA picture CRA_N_LP having no leading picture.

Meanwhile, a point where different bitstreams are connected by bitstream slicing is referred to as a broken link. A picture of a point in which a new bitstream starts by such bitstream slicing is defined as a BLA picture that is the same as the CRA picture except that the BLA picture is generated by performing a slicing operation. The CRA picture may be changed to the BLA picture by performing the slicing operation.

The BLA picture, which is also an I picture, initializes a DPB at the instant that the BLA picture is decoded similar to the IDR picture. Normal pictures that follow the BLA picture in a decoding order and an output order may not refer to a picture prior to the BLA picture. However, the BLA picture is allowed to use a leading picture to use a picture decoded prior to the BLA picture as a reference picture. That is, in the BLA picture, a picture referring to a picture decoded prior to the BLA picture may exist among leading pictures that are pictures following the BLA picture in the decoding order but preceding the BLA picture in an output order. When random access starts from the BLA picture, since some leading pictures use a reference picture that may not be used at a random access point, they may not be decoded.

Thus, BLA pictures may be classified as i) the BLA picture BLA_N_LP having no leading picture, ii) the BLA picture BLA_W_RADL having a RADL picture, and iii) the BLA picture BLA_W_RASL having an RASL picture. The reason why BLA pictures are classified as described above is that when the BLA picture has an RASL picture, the RASL picture may be discarded without being decoded during the random access. A decoding apparatus may previously determine whether an RASL picture of which decoding is not necessary at a decoding time exists, and, when receiving an NAL unit bitstream including the RASL picture, may skip an unnecessary decoding process on a corresponding RASL picture.

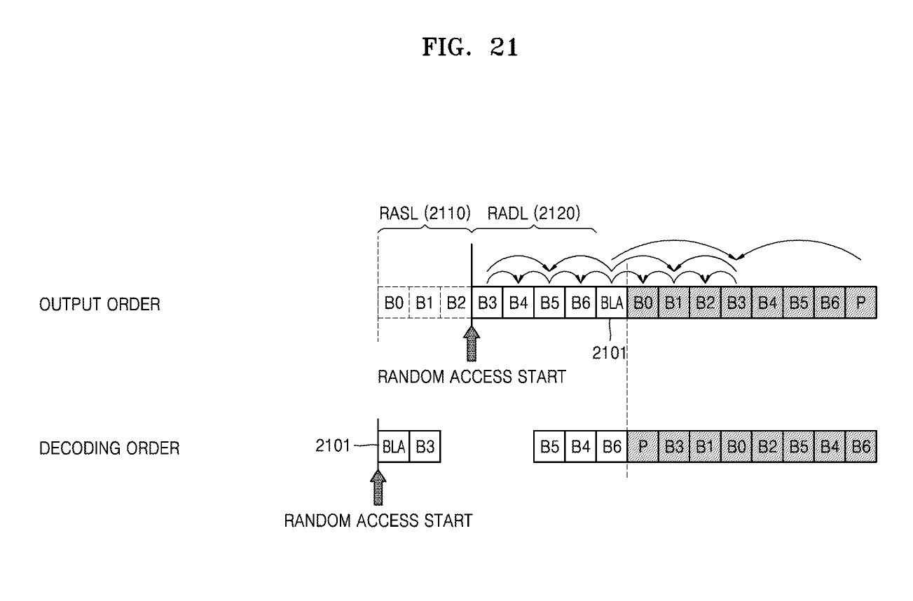

FIG. 21 shows an example of an RASL picture and an RADL picture with respect to a BLA picture. In FIG. 21, it is assumed that B0 through B2 pictures 2110 are pictures that refer to a picture preceding a BLA picture 2101 in a decoding order, and B3 through B6 pictures 2101 are also pictures that refer to the BLA picture 2101 or a picture decoded after the BLA picture 2101. Since random access starts by decoding the BLA picture 2101, the picture referred to by the B0 through B2 pictures 2110 may not be used. Thus, the B0 through B2 pictures 2110 correspond to RASL pictures that may not be decodable. B3 through B6 pictures 2120 use only a picture decoded after the BLA picture 2101 as a reference picture, and thus they correspond to RADL pictures that may be decodable during a random access. The video encoding apparatus 1600 classifies a corresponding BLA picture as the BLA picture BLA_W_RASL having the RASL picture when the RASL picture exists among leading pictures of the BLA picture.

Similarly to the IDR picture IDR_W_RADL having the RASL picture of FIG. 19A described above, when leading pictures of the BLA picture are RADL pictures, the BLA picture is the BLA picture BLA_W_RADL having a leading picture. Similarly to the IDR picture IDR_N_LP having a leading picture of FIG. 19B described above, when no leading picture of the BLA picture exists, the BLA picture is the BLA picture BLA_N_LP having no leading picture.

Meanwhile, the temporal identifier temporal_id is included in the NAL unit header of FIG. 15 described above to support temporal scalability. The temporal identifier temporal_id indicates a level in a hierarchical temporal prediction structure.

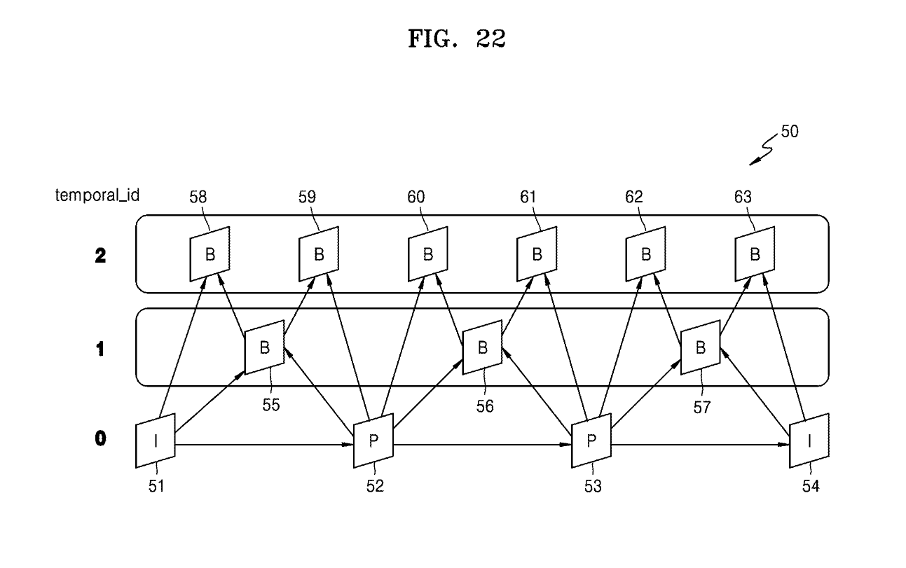

FIG. 22 illustrates a hierarchical temporal prediction structure 50 according to an embodiment of the present invention.

Referring to FIG. 22, temporal scalability may be implemented by changing a reproduced time hierarchy in the hierarchical temporal prediction structure 50. For example, if a frame rate is 15 Hz when only pictures 51, 52, 53, and 54 of a level 0 in which the temporal identifier temporal_id is 0 are reproduced, the frame rate is 30 Hz when only pictures 55, 56, and 57 of a level 1 in which the temporal identifier temporal_id is 2 are reproduced, and the frame rate is 60 Hz when only pictures 58 though 63 of a level 2 in which the temporal identifier temporal_id is 2 are reproduced. Pictures of a lower temporal level are limited not to refer to pictures of an upper temporal level in order to enable reproduction at a low frame rate when the pictures of the lower temporal level are received. For example, when pictures having the temporal identifier temporal_id of 0 are only received, a picture referring to the pictures of the upper temporal level among the pictures having the temporal identifier temporal_id of 0 may not be normally decoded. Thus, to enable normal reproduction when some pictures are received, the pictures of the lower temporal level may be limited not to refer to the pictures of the upper temporal level.

A TSA picture and an STSA picture are pictures accessed in temporal switching at which a frame rate is changed for temporal scalability.

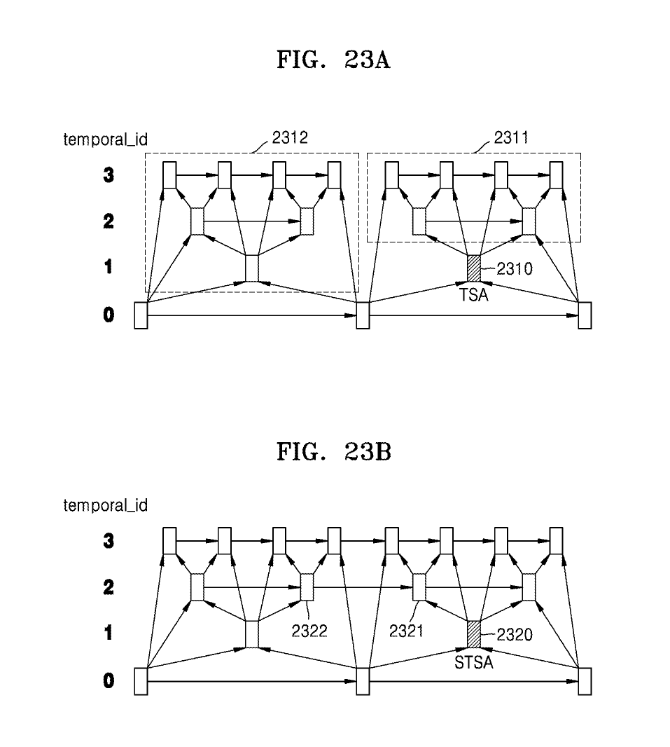

FIG. 23A is a diagram of a TSA picture 2310 according to an exemplary embodiment of the present invention. FIG. 23B is a diagram of a STSA picture 2320 according to an exemplary embodiment of the present invention.

A TSA picture and pictures having a same temporal level as or a higher temporal level than that of the TSA picture and being decoded after the TSA picture may not refer to other pictures preceding the TSA picture in a decoding order and having the same temporal level as or the higher temporal level than that of the TSA picture. An existence of the TSA picture satisfying such a condition indicates that temporal switching may occur from a lower temporal level to an arbitrary upper temporal level. Referring to FIG. 23A, the TSA picture 2310 may not refer to other pictures 2312 preceding the TSA picture 2310 in a decoding order and having the same temporal level as or the higher temporal level than that of the TSA picture 2310. Pictures 2311 having a same temporal level as or an higher temporal level than that of the TSA picture 2310 and decoded after the TS picture 2310 may not refer to the other pictures 2312 preceding the TSA picture 2310 in a decoding order and having the same temporal level as or the higher temporal level than that of the TSA picture 2310.

A STSA picture and pictures having a same temporal level as that of the STSA picture and being decoded after the TSA picture may not refer to other pictures preceding the STSA picture in a decoding order and having the same temporal level as or a higher temporal level than that of the STSA picture. Upon comparing the STSA picture and the TSA picture, the TSA picture, in which pictures having a higher temporal level than that of the TSA picture and being decoded after the TSA picture may not refer to other pictures preceding the TSA picture in a decoding order and having the same temporal level as or the higher temporal level than that of the TSA picture, is different from the STSA picture in which pictures having a higher temporal level than that of the STSA picture and being decoded after the STSA picture may refer to other pictures preceding the STSA picture in a decoding order and having the same temporal level as or the higher temporal level than that of the STSA picture. Referring to FIG. 23B, a picture 2321 is a picture having a higher temporal level than that of the STSA picture 2320 and may refer to a picture 2322 preceding the STSA picture 2320 in the decoding order and having the higher temporal level than that of the STSA picture 2320. An existence of the STSA picture indicates that temporal switching may occur from a lower temporal level to a higher temporal level by one level. In other words, when the STSA picture exists, temporal switching from a level of n having the temporal identifier temporal_id of n (where n is an integer) to an upper temporal hierarchy may be performed to only an upper level of n+1 having the temporal identifier temporal_id of n+1. Temporal switching from the upper temporal level to the lower temporal level may be performed without limitation.

TSA pictures may be classified as i) a TSA picture TSA_R used as a reference picture of another picture and ii) a TSA picture TSA_N that is not used as the reference picture of another picture, according to whether a TSA picture is used as the reference picture of another picture.

The TSA picture is a picture referring to a picture of a lower temporal hierarchy and may not be decodable according to a prediction structure. Thus, TSA pictures may be classified as i) a TSA picture RASL_TSA_R that is not decodable and is used as a reference picture of another picture and ii) a TSA picture RASL_TSA_N that is not decodable and is not used as the reference picture of another picture.

Similarly, STSA pictures may be classified as i) a STSA picture STSA_R used as a reference picture of another picture and ii) a STSA picture STSA_N that is not used as the reference picture of another picture, according to whether a STSA picture is used as the reference picture of another picture.

The STSA picture is a picture referring to a picture of a lower temporal hierarchy and may not be decodable according to a prediction structure. Thus, STSA pictures may be classified as i) a STSA picture RASL_STSA_R that is not decodable and is used as a reference picture of another picture and ii) a STSA picture RASL_STSA_N that is not decodable and is not used as the reference picture of another picture.

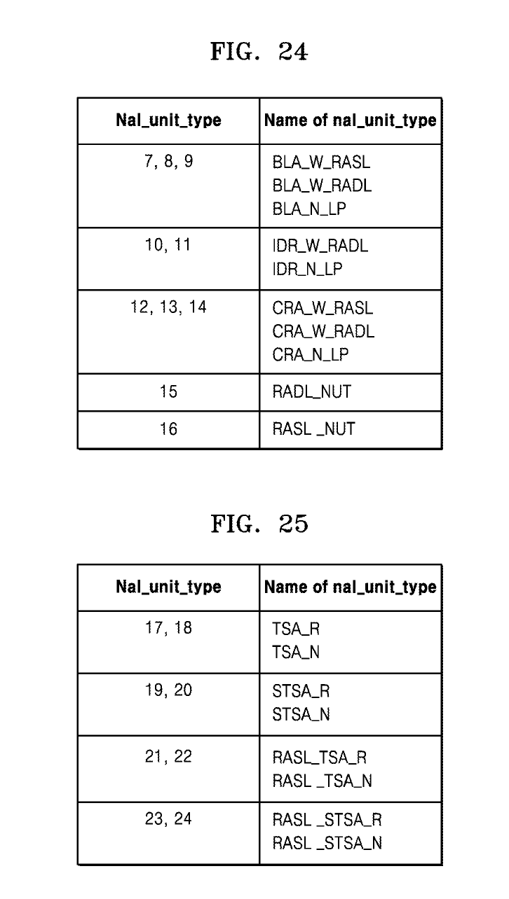

FIG. 24 illustrates an example of type information of an RAP picture according to an exemplary embodiment of the present invention.

As described above, the video encoding apparatus 1600 classifies RAP pictures based on whether leading pictures that precede the RAP pictures in an output order but are decoded after the RAP pictures for random access in a decoding order of a decoder exists and whether a RADL picture exists among the leading pictures, and generates a NAL unit of a VCL including type information of the classified RAP pictures.

Referring to FIG. 24, the video encoding apparatus 1600 may i) add nal_unit_type having a value of 11 to a header of a NAL unit including information regarding the IDR picture IDR_N_LP having no leading picture and ii) add nal_unit_type having a value of 10 to a header of a NAL unit including information regarding the IDR picture IDR_W_LP having an RADL picture that is a decodable leading picture.

The video encoding apparatus 1600 may i) add nal_unit_type having a value of 14 to a header of a NAL unit including information regarding the CRA picture CRA_N_LP having no leading picture, ii) add nal_unit_type having a value of 13 to a header of a NAL unit including information regarding the CRA picture CRA_W_RADL having an RADL picture, and iii) add nal_unit_type having a value of 12 to a header of a NAL unit including information regarding the CRA picture CRA_W_RASL having an RASL picture.

The video encoding apparatus 1600 may i) add nal_unit_type having a value of 9 to a header of a NAL unit including information regarding the BLA picture BLA_N_LP having no leading picture, ii) add nal_unit_type having a value of 8 to a header of a NAL unit including information regarding the BLA picture BLA_W_RADL having an RADL picture, and iii) add nal_unit_type having a value of 7 to a header of a NAL unit including information regarding the BLA picture BLA_W_RASL having an RASL picture.

The value of nal_unit_type according to the type of the RAP picture described above is not limited to the example of FIG. 24 but may be changed.

FIG. 25 illustrates an example of type information of a TSA picture and an STSA picture according to an exemplary embodiment of the present invention.

The video encoding apparatus 1600 may i) add nal_unit_type having a value of 17 to a header of a NAL unit including information regarding the TSA picture TSA_R used as a reference picture of another picture and ii) add nal_unit_type having a value of 18 to a header of a NAL unit including information regarding the TSA picture TSA_N that is not used as a reference picture of another picture. The video encoding apparatus 1600 may i) add nal_unit_type having a value of 21 to a header of a NAL unit including information regarding the TSA picture RASL_TSA_R that is not decodable and is used as a reference picture of another picture, and ii) add nal_unit_type having a value of 22 to a header of a NAL unit including information regarding the TSA picture RASL_TSA_N that is not decodable and is not used as a reference picture of another picture.

The video encoding apparatus 1600 may i) add nal_unit_type having a value of 19 to a header of a NAL unit including information regarding the STSA picture STSA_R used as a reference picture of another picture and ii) add nal_unit_type having a value of 20 to a header of a NAL unit including information regarding the STSA picture STSA_N that is not used as a reference picture of another picture. The video encoding apparatus 1600 may i) add nal_unit_type having a value of 23 to a header of a NAL unit including information regarding the STSA picture RASL_STSA_R that is not decodable and is used as a reference picture of another picture, and ii) add nal_unit_type having a value of 24 to a header of a NAL unit including information regarding the STSA picture RASL_STSA_N that is not decodable and is not used as a reference picture of another picture.

The video encoding apparatus 1600 according to an exemplary embodiment subdivides types of RAP pictures for random access, thereby allowing a decoding apparatus to prepare for a decoding process and determine a type of a RAP picture included in an input NAL unit and an existence of a discardable NAL unit in advance.

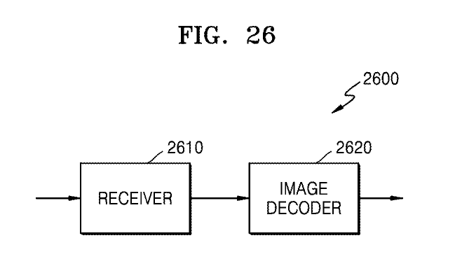

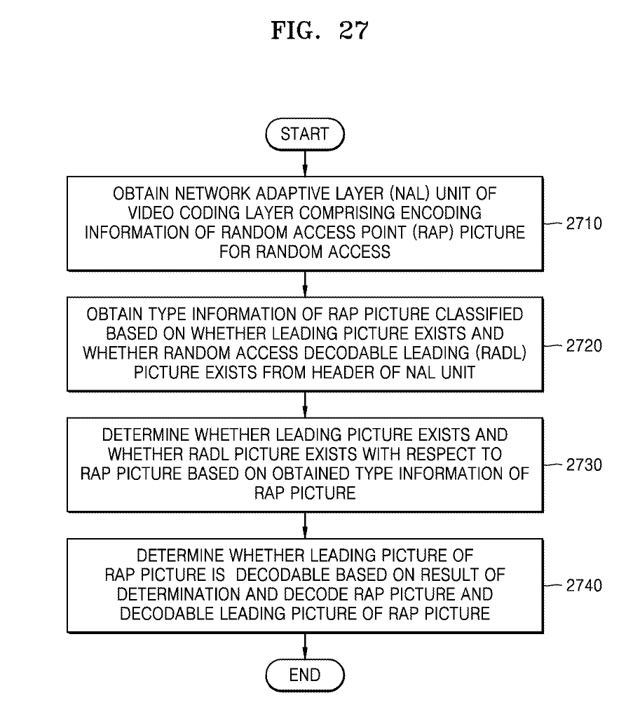

FIG. 26 is a block diagram of a video decoding apparatus 2600 according to an exemplary embodiment of the present invention. FIG. 27 is a flowchart of a video decoding method according to an exemplary embodiment of the present invention.

Referring to FIGS. 26 and 27, the video decoding apparatus 2600 includes a receiver 2610 and an image decoder 2620.

In operation S2710, the receiver 2610 obtains an NAL unit of a VCL including encoding information of RAP pictures for random access. In operation S2720, the receiver 2610 obtains type information nal_unit_type of the RAP pictures classified based on whether leading pictures that precede the RAP pictures in an output order but are decoded after the RAP pictures in a decoding order exist and whether a RADL picture exists among the leading pictures, from a header of the NAL unit.

In operation S2730, when a picture included in a current NAL unit included in the header of the NAL unit is an IDR picture, the receiver 2610 may determine whether i) the IDR picture is the IDR picture IDR_N_LP having no leading picture and ii) the IDR picture is the IDR picture IDR_W_LP having an RADL picture that is a decodable leading picture based on nal_unit_type. When the picture included in the current NAL unit included in the header of the NAL unit is a CRA picture, the receiver 2610 may determine a type of the CRA picture among i) the CRA picture CRA_N_LP having no leading picture, ii) the CRA picture CRA_W_RADL having an RADL picture, and iii) the CRA picture CRA_W_RASL having an RASL picture based on nal_unit_type. The receiver 2610 may determine a type of a BLA picture among i) the BLA picture BLA_N_LP having no leading picture, ii) the BLA picture BLA_W_RADL having an RADL picture, and iii) the BLA picture BLA_W_RASL having an RASL picture based on nal_unit_type.

The receiver 2610 may determine types of a TSA picture and an STSA picture based on nal_unit_type.

In operation S2740, the image decoder 2620 performs decoding based on coding units of a tree structure like the image decoder 400 of FIG. 5 described above. In particular, the image decoder 2620 may determine whether a leading picture exists and whether an RDK picture exists with respect to the RAP picture based on the type information of the obtained RAP picture and determine whether to decode the leading picture of the RAP picture based on a result of the determination. When different values of nal_unit_type are set with respect to the RADL picture and the RASL picture, and nal_unit_type is added to the header of the NAL unit including the RADL picture or the RASL picture, the video decoding apparatus 2600 may analyze only nal_unit_type included in the header of the NAL unit to determine whether a current picture is a decodable picture. A separate decoding process is skipped on the NAL unit including the RASL picture.

The embodiments of according to the present invention may be written as computer programs and may be implemented in general-use digital computers that execute the programs by using a computer-readable recording medium. Examples of the computer-readable recording medium include magnetic storage media (e.g., a read-only memory (ROM), a floppy disc, and a hard disc), optically readable media (e.g., a compact disc-read only memory (CD-ROM) and a digital versatile disc (DVD)), and carrier waves (such as data transmission through the Internet).

While the present invention has been particularly shown and described with reference to exemplary embodiments thereof, it will be understood by those of ordinary skill in the art that various changes in form and details may be made therein without departing from the spirit and scope of the invention as defined by the appended claims. The exemplary embodiments should be considered in a descriptive sense only and not for purposes of limitation. Therefore, the scope of the invention is defined not by the detailed description of the invention but by the appended claims, and all differences within the scope will be construed as being included in the present invention.

1. A video decoding method comprising:
obtaining a network adaptive layer (NAL) unit of a video coding layer comprising encoding information of a random access point (RAP) picture for random access;
obtaining type information of the RAP picture classified based on whether a leading picture that precedes the RAP picture in an output order but is decoded after the RAP picture in a decoding order exists and whether a random access decodable leading (RADL) picture exists among the leading picture, from a header of the NAL unit;
determining whether the leading picture exists and whether the RADL picture exists with respect to the RAP picture based on the obtained type information of the RAP picture; and
decoding the RAP picture and the decodable leading picture of the RAP picture by determining whether the leading picture of the RAP picture is decodable based on a result of the determining.

2. The video decoding method of claim 1, wherein the RAP picture is an instantaneous decoding refresh (IDR) picture,
wherein the IDR picture is classified as a first IDR picture having a decodable leading picture and a second IDR picture having no leading picture, and
wherein the first IDR picture and the second IDR picture have different pieces of type information of the NAL unit.

3. The video decoding method of claim 1, wherein the RAP picture is a broken link access (BLA) picture,
wherein the BLA picture is classified as a first BLA picture having a non-decodable leading picture, a second BLA picture having a decodable leading picture, and a third BLA picture having no leading picture, and
wherein the first BLA picture, the second BLA picture, and the third BLA picture have different pieces of type information of the NAL unit.

4. The video decoding method of claim 1, wherein the RAP picture is a clean random access (CRA) picture,
wherein the CRA picture is classified as a first CRA picture having a non-decodable leading picture, a second CRA picture having a decodable leading picture, and a third CRA picture having no leading picture, and
wherein the first CRA picture, the second CRA picture, and the third CRA picture have different pieces of type information of the NAL unit.

5. The video decoding method of claim 1, wherein a non-decodable leading picture among the leading picture is not decoded but is discarded based on a result of the determining.

6. The video decoding method of claim 1, further comprising: obtaining a NAL unit comprising encoding information of a temporal sub-layer access (TSA) picture or a step-wise temporal sub-layer access (STSA) picture in temporal switching in which a frame rate is changed for temporal scalability,
wherein the TSA picture and a picture decoded after the TSA picture do not use a picture having the same temporal hierarchy as or a higher temporal hierarchy than that of the TSA picture as a reference picture, and
wherein the STSA picture and pictures decoded after the STSA picture and having the same temporal hierarchy as that of the STSA picture do not use a picture decoded prior to the STSA picture and having the same temporal hierarchy as or a higher temporal hierarchy than that of the STSA picture as a reference picture, and
wherein the TSA picture and the STSA picture have different pieces of type information of the NAL unit.

7. The video decoding method of claim 6,
wherein the TSA picture is classified as a first TSA picture and a second TSA picture according to whether the TSA picture is used as a reference picture of another picture, and the first TSA picture and the second TSA picture have different pieces of type information of the NAL unit, and
wherein the STSA picture is classified as a first STSA picture and a second STSA picture according to whether the STSA picture is used as a reference picture of another picture, and the first STSA picture and the second STSA picture have different pieces of type information of the NAL unit.

8. A video decoding apparatus comprising:
a receiver for obtaining a network adaptive layer (NAL) of a video coding layer comprising encoding information of a random access point (RAP) picture for random access, and obtaining type information of the RAP picture classified based on whether a leading picture that precedes the RAP picture in an output order but is decoded after the RAP picture in a decoding order exists and whether a random access decodable leading (RADL) picture exists among the leading picture, from a header of the NAL unit; and
an image decoder for determining whether the leading picture exists and whether the RADL picture exists with respect to the RAP picture based on the obtained type information of the RAP picture, and determining whether the leading picture of the RAP picture is decodable based on a result of the determining and decoding the RAP picture and the decodable leading picture of the RAP picture.

9. A video encoding method comprising:
encoding pictures constituting an image sequence by performing inter prediction and intra prediction; and
classifying a random access point (RAP) picture based on whether a leading picture that precedes the RAP picture according to an output order but is decoded after the RAP picture according to a decoding order of a decoder exists and whether a random access decodable leading (RADL) picture exists among the leading picture, and generating a network adaptive layer (NAL) unit of a video coding layer comprising encoding information of the RAP picture and type information of the classified RAP picture.

10. The video encoding apparatus of claim 9, wherein the RAP picture is a broken link access (BLA) picture,
wherein the BLA picture is classified as a first BLA picture having a non-decodable leading picture, a second BLA picture having a decodable leading picture, and a third BLA picture having no leading picture, and
wherein the first BLA picture, the second BLA picture, and the third BLA picture have different pieces of type information of the NAL unit.

11. The video encoding method of claim 9, wherein the RAP picture is a clean random access (CRA) picture,
wherein the CRA picture is classified as a first CRA picture having a non-decodable leading picture, a second CRA picture having a decodable leading picture, and a third CRA picture having no leading picture, and
wherein the first CRA picture, the second CRA picture, and the third CRA picture have different pieces of type information of the NAL unit.

12. The video encoding method of claim 9, further comprising: adding type information for identifying a non-decodable leading picture to a header of the NAL unit when the decoder performs random access to the RAP picture as a leading picture of the RAP picture among the encoded pictures.

13. The video encoding method of claim 9, further comprising: generating a NAL unit comprising encoding information of a temporal sub-layer access (TSA) picture or a step-wise temporal sub-layer access (STSA) picture in temporal switching in which a frame rate is changed for temporal scalability,
wherein the TSA picture and a picture decoded after the TSA picture do not use a picture having the same temporal hierarchy as or a higher temporal hierarchy than that of the TSA picture as a reference picture, and
wherein the STSA picture and pictures decoded after the STSA picture and having the same temporal hierarchy as that of the STSA picture do not use a picture decoded prior to the STSA picture and having the same temporal hierarchy as or a higher temporal hierarchy than that of the STSA picture as a reference picture, and
wherein the TSA picture and the STSA picture have different pieces of type information of the NAL unit.

14. The video encoding method of claim 13,
wherein the TSA picture is classified as a first TSA picture and a second TSA picture according to whether the TSA picture is used as a reference picture of another picture, and the first TSA picture and the second TSA picture have different pieces of type information of the NAL unit, and
wherein the STSA picture is classified as a first STSA picture and a second STSA picture according to whether the STSA picture is used as a reference picture of another picture, and the first STSA picture and the second STSA picture have different pieces of type information of the NAL unit.

15. A video encoding apparatus comprising:
an image encoder for encoding pictures constituting an image sequence by performing inter prediction and intra prediction; and
an output unit for classifying a random access point (RAP) picture based on whether a leading picture that precedes the RAP picture in an output order but is decoded after the RAP picture in a decoding order of a decoder exists and whether a random access decodable leading (RADL) picture exists among the leading picture, and generating a network adaptive layer (NAL) unit of a video coding layer comprising encoding information of the RAP picture and type information of the classified RAP picture.
